(19) United States
(12) Patent Application Publication
(10) Pub. No.: US 2023/0333521 A1
(43) Pub. Date: Oct. 19, 2023

(54) MACHINE LEARNING-BASED OPTIMIZATION OF THERMODYNAMIC POWER GENERATION

(71) Applicant: C3.ai, Inc., Redwood City, CA (US)

(72) Inventors: Timothy P. Holtan, Naperville, IL (US); Qiwei Li, Fremont, CA (US); Shouvik Mani, New York City, NY (US); Suman Tripathy, Pleasanton, CA (US)

(21) Appl. No.: 18/300,215

(22) Filed: Apr. 13, 2023

Related U.S. Application Data
(60) Provisional application No. 63/331,021, filed on Apr. 14, 2022.

(51) Int. Cl. G05B 13/02

(52) U.S. Cl. CPC G05B 13/0265; G05B 13/021; G05B 13/026

(57) ABSTRACT

A method includes analyzing information to be processed, where analyzing the information includes classifying invalid data contained in the information and substituting replacement data in place of at least some of the invalid data in the information. The method also includes training at least one machine learning model based on some of the analyzed information. The method further includes providing other of the analyzed information to the at least one trained machine learning model, where the at least one trained machine learning model is used to generate one or more recommendations based on the analyzed information. In addition, the method includes translating each of the one or more recommendations into one or more actions and generating one or more control instructions based on the one or more actions for at least one of the one or more recommendations.

### CROSS-REFERENCE TO RELATED APPLICATION AND PRIORITY CLAIM

This application claims priority under 35 U.S.C. § 119(e) to U.S. Provisional Pat. Application No. 63/331,021 filed on Apr. 14, 2022. This provisional application is hereby incorporated by reference in its entirety.

### TECHNICAL FIELD

This disclosure is generally directed to machine learning systems. More specifically, this disclosure is directed to machine learning-based optimization of thermodynamic power generation.

### BACKGROUND

Many industrial facilities and other facilities include thermodynamic power generation systems, which typically include turbogenerators or other power generation components that produce electricity using steam or other heat sources. Various systems use steam to achieve one or more desired functions. For example, a manufacturing plant or other plant may use steam during the production of one or more products or materials. In some cases, a cogeneration facility may be used as a standalone facility or as part of a larger system, such as a manufacturing plant or other plant. A cogeneration facility refers to a facility that produces heat and electricity, and some cogeneration facilities can use steam as part of the overall heat and electricity-generating process. As a particular example, in some manufacturing plants or other plants, higher-pressure steam may be produced or used during part of the manufacturing process, and the higher-pressure steam may be provided to a cogeneration facility for conversion to lower-pressure steam (along with the generation of electricity as part of the conversion process).

### SUMMARY

This disclosure relates to machine learning-based optimization of thermodynamic power generation.

In a first embodiment, a method includes analyzing information to be processed, where analyzing the information includes classifying invalid data contained in the information and substituting replacement data in place of at least some of the invalid data in the information. The method also includes training at least one machine learning model based on some of the analyzed information. The method further includes providing other of the analyzed information to the at least one trained machine learning model, where the at least one trained machine learning model is used to generate one or more recommendations based on the analyzed information. In addition, the method includes translating each of the one or more recommendations into one or more actions and generating one or more control instructions based on the one or more actions for at least one of the one or more recommendations.

In a second embodiment, an apparatus includes at least one processing device configured to analyze information to be processed. To analyze the information, the at least one processing device is configured to classify invalid data contained in the information and substitute replacement data in place of at least some of the invalid data in the information. The at least one processing device is also configured to train at least one machine learning model based on some of the analyzed information. The at least one processing device is further configured to provide other of the analyzed information to the at least one trained machine learning model and generate one or more recommendations based on the analyzed information. In addition, the at least one processing device is configured to translate each of the one or more recommendations into one or more actions and generate one or more control instructions based on the one or more actions for at least one of the one or more recommendations.

In a third embodiment, a non-transitory machine readable medium contains instructions that when executed cause at least one processor to analyze information to be processed. The instructions that when executed cause the at least one processor to analyze the information include instructions that when executed cause the at least one processor to classify invalid data contained in the information and substitute replacement data in place of at least some of the invalid data in the information. The non-transitory machine readable medium also contains instructions that when executed cause the at least one processor to train at least one machine learning model based on some of the analyzed information. The non-transitory machine readable medium further contains instructions that when executed cause the at least one processor to provide other of the analyzed information to the at least one trained machine learning model and generate one or more recommendations based on the analyzed information. In addition, the non-transitory machine readable medium contains instructions that when executed cause the at least one processor to translate each of the one or more recommendations into one or more actions and generate one or more control instructions based on the one or more actions for at least one of the one or more recommendations.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting machine learning-based optimization of thermodynamic power generation according to this disclosure;

FIGS. 2A through 2C illustrate an example device and related details supporting machine learning-based optimization of thermodynamic power generation according to this disclosure;

FIG. 3 illustrates an example thermodynamic power generation system according to this disclosure;

FIG. 4 illustrates an example graph identifying regressions used to create machine learning models to support machine learning-based optimization of thermodynamic power generation according to this disclosure;

FIG. 5 illustrates an example usage of multiple machine learning models to support machine learning-based optimization of thermodynamic power generation according to this disclosure;

FIG. 6 illustrates an example definition of historical bounds used to support machine learning-based optimization of thermodynamic power generation according to this disclosure;

FIGS. 7A through 9 illustrate an example graphic user interface that can be used to support machine learning-based optimization of thermodynamic power generation according to this disclosure;

FIG. 10 illustrates an example method for machine learning-based optimization of thermodynamic power generation according to this disclosure;

FIG. 11 illustrates an example method for pre-processing data during machine learning-based optimization of thermodynamic power generation according to this disclosure;

FIG. 12 illustrates an example method for performing machine learning model substitution during machine learning-based optimization of thermodynamic power generation according to this disclosure; and

FIG. 13 illustrates an example method for machine learning-based optimization of a specific steam-based thermodynamic power generation system according to this disclosure.

### DETAILED DESCRIPTION

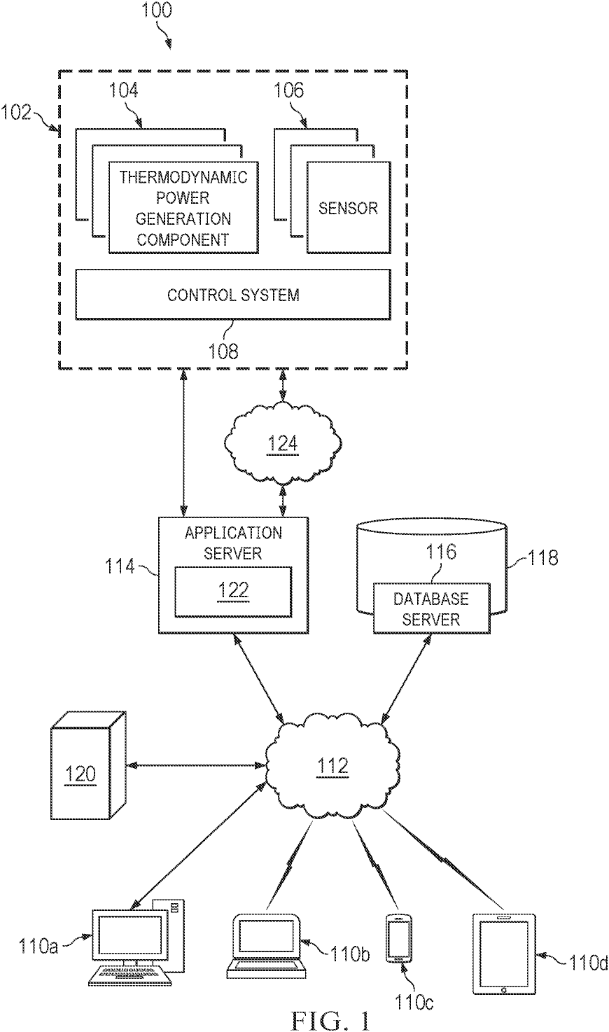

FIGS. 1 through 13, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, many industrial facilities and other facilities include thermodynamic power generation systems, which typically include turbogenerators or other power generation components that produce electricity using steam or other heat sources. Various systems use steam to achieve one or more desired functions. For example, a manufacturing plant or other plant may use steam during the production of one or more products or materials. In some cases, a cogeneration facility may be used as a standalone facility or as part of a larger system, such as a manufacturing plant or other plant. A cogeneration facility refers to a facility that produces heat and electricity, and some cogeneration facilities can use steam as part of the overall heat and electricity-generating process. As a particular example, in some manufacturing plants or other plants, higher-pressure steam may be produced or used during part of the manufacturing process, and the higher-pressure steam may be provided to a cogeneration facility for conversion to lower-pressure steam (along with the generation of electricity as part of the conversion process).

The ability to increase or maximize the usage of steam or other heat source(s) in a manufacturing plant, cogeneration facility, or other facility or to otherwise increase or maximize thermodynamic power generation may be highly desirable. For example, the production of higher-pressure steam typically involves the usage of a large amount of electrical, thermal, chemical, or other energy, and the ability to generate electricity from higher-pressure steam can help to recycle some of the energy within a facility. Among other things, the ability to recycle energy can reduce a facility’s carbon footprint and can result in large cost savings. Some systems include turbogenerators that are designed to receive steam at higher pressures and that output steam at medium or lower pressures while producing electricity. This is one example of how energy may be recycled using high-pressure steam. Note that the terms “higher,” “medium,” and “lower” in this document refer to different pressures or ranges of pressures and are not limited to any specific pressure values or ranges.

Unfortunately, some steam-based systems or other thermodynamic power generation systems can be extremely complex and involve hundreds of components or more, including multiple turbogenerators or other components that can be separately fed and controlled. In these or other types of systems, there may be a very large amount of data that is generated, and it can be difficult to control the operations of the multiple turbogenerators or other components in a way that achieves at least one desired goal (such as maximum power generation, maximum power efficiency, minimized energy usage, or minimized cost). Some prior approaches have attempted to use more-limited physics-based or math-based solutions, such as approaches that simply use mass balance equations, to control multiple turbogenerators or other components. However, these approaches have failed due to the overall complexities of the systems and in some instances have even been declared unsolvable. Moreover, it is relatively common for a facility to have multiple years’ worth of stored data related to operations of the facility over that time period, and the qualities of different information in the stored data can vary greatly depending on the circumstances. Along with the large range of properties for both thermodynamic power generators and power consumers and the interplay of different variables associated with any given facility, this can make it extremely difficult for facility operators to create control schemes for controlling the operations of the multiple turbogenerators or other components in a way that achieves the at least one desired goal.

This disclosure provides an apparatus, method, and computer readable medium supporting machine learning-based optimization of thermodynamic power generation. Among other things, this allows for control optimization of a steam-based system or other thermodynamic power generation system using one or more machine learning models. As described in more detail below, one or more machine learning regression algorithms or other machine learning algorithms can be used in modeling outputs of turbogenerators or other thermodynamic power generation components in a system. For example, one or more machine learning models may be used to predict the amount of power generated by the multiple turbogenerators or other thermodynamic power generation components in the system. In some cases, the one or more machine learning models may use only information associated with input and extraction (also known as output) flows of steam or other material into and out of each turbogenerator or other thermodynamic power generation component as inputs, although machine learning models that use other or additional inputs may also be created and used here.

The one or more machine learning models here may be trained to operate based on characteristics of the overall steam-based system or other thermodynamic power generation system. For example, measurements or other information obtained from various thermodynamic sensors (or information derived from the measurements or other information obtained from the various thermodynamic sensors) may be processed using the one or more machine learning models. The thermodynamic sensors may include any suitable type(s) of sensor(s), such as sensors that measure pressure, temperature, flow rate, or other characteristics of steam or other flows of material. The one or more machine learning models can process this information (optionally along with any other suitable information) in order to predict and optimize power generation by the turbogenerators or other thermodynamic power generation components.

After suitable modeling of the multiple turbogenerators or other thermodynamic power generation components, steam flows or other flows to the multiple turbogenerators or other thermodynamic power generation components can be optimized subject to various physical and engineering constraints and demands of a facility. For example, physical constraints may include time-series data from sensors representing energy balances, mass balances, and momentum balances, and engineering constraints may include static data representing materials of construction, physical configurations, and arrangements of unit operations within a given facility. As particular examples, the physical constraints may include aspects such as mass balances, material demands, historical and manufacturer flow maximums, and other characteristics of the facility. The constraints can also bound values within realistic limits rather than theoretical limits, and unmetered flows of steam or other material within the facility can be predicted as needed. The entire physical system can be captured here, and all constraints associated with the facility can be satisfied during optimization.

Control optimization guidance can be generated to identify a configuration of the thermodynamic power generation system, such as a configuration of valve settings or other settings to control how steam or other material is provided to the turbogenerators or other thermodynamic power generation components. The control optimization guidance can satisfy all constraints associated with the facility. In some cases, the flows of steam or other material to or from the turbogenerators or other thermodynamic power generation components can be optimized using an objective function, which can be tailored to achieve a specific type of result, such as maximum power production, minimum environmental emissions, optimum steam flows or other material flows to support heat requirements in a facility, optimum routings of associated steam or other material flows, optimum disposition of waste streams, and minimum cost of fuel and supporting chemicals. In some cases, each of these results may be expressed as time-series values.

In this way, it is possible to optimize the flows of steam or other material to or from multiple turbogenerators or other thermodynamic power generation components in a facility in order to obtain a desired result, such as increased or maximized power production. Moreover, this can be achieved even in complex systems having numerous components, and realistic operations of the facility can be considered when making optimization decisions to help ensure that control optimization guidance is actually feasible. In addition, these approaches can be used in the presence of large amounts of data, even when the data varies in quality, there is a large range of properties for both thermodynamic power generators and power consumers, and different variables associated with any given facility can interact differently. This is because the one or more machine learning models and other components can be used to effectively optimize the flows of steam or other material to or from multiple turbogenerators or other thermodynamic power generation components in the presence of these issues.

Note that the control optimization guidance generated here can be used in any suitable manner, such as when control optimization guidance (or information based on the control optimization guidance) is provided to one or more human operators for consideration and approval/implementation or when control optimization guidance (or information based on the control optimization guidance) is provided to an automated control system for generating control instructions in order to adjust operation of components in the facility. In some instances, for example, one or more control instructions that control how steam or other material is routed to or from the turbogenerators or other thermodynamic power generation components of the facility may be generated, possibly after user approval is obtained. As a particular example, the one or more control instructions may be routed to or from one or more components that regulate at least one resource (such as steam or other material) in order to implement an optimization strategy, such as to automatically control valve actuators or other components of the facility. Also note that example implementations provided in this disclosure can handle different cases with machine learning algorithms as well as mathematical relationships and formulas. For instance, an operator at a facility may be able to directly input optimization variables’ values (such as flow). In other examples, facilities may use setpoint conversions, such as flow optimization variables to pressure setpoints.

FIG. 1 illustrates an example system 100 supporting machine learning-based optimization of thermodynamic power generation according to this disclosure. As shown in FIG. 1, the system 100 includes or is used in conjunction with at least one thermodynamic power generation system 102. In this example, the thermodynamic power generation system 102 includes multiple thermodynamic power generation components 104 (also referred to as thermodynamic power generators), which are generally configured to produce electrical energy based on steam or other heat source. In some cases, the steam may be produced by other components of the thermodynamic power generation system 102 or by another system that is collocated or otherwise used in conjunction with the thermodynamic power generation system 102. As a particular example, the steam may be provided by a manufacturing or processing plant or other plant that produces or processes one or more materials, such as to produce one or more finished goods or other products. Each thermodynamic power generation component 104 represents any suitable structure configured to generate electricity based on thermal energy, such as a turbogenerator or other generator.

In this example, various thermodynamic sensors 106 may be associated with the thermodynamic power generation components 104 specifically or with the thermodynamic power generation system 102 generally. The thermodynamic sensors 106 can be used to measure or otherwise sense one or more characteristics (such as pressure, temperature, flow rate, or any combination thereof) associated with the operation of the thermodynamic power generation components 104 or the thermodynamic power generation system 102. For example, the thermodynamic sensors 106 may be used to measure or otherwise sense one or more characteristics associated with flows of steam or other material to or from the thermodynamic power generation components 104. As particular examples, the thermodynamic sensors 106 may measure pressure, temperature, flow rate, or any other or additional characteristics (or any combination thereof) of steam flowing to or from the thermodynamic power generation components 104.

At least one thermodynamic control system 108 may be used here to control operation of the thermodynamic power generation components 104 specifically and the thermodynamic power generation system 102 generally. For example, the thermodynamic control system 108 may be used to control valve actuators that are configured to control how valves are opened and closed, where the valves control the actual flows of steam or other material to or from the thermodynamic power generation components 104. The control system 108 may control other or additional characteristics of the thermodynamic power generation system 102, such as by controlling the pressures or temperatures of steam flows or other material flows, feedstocks or catalysts used to produce the steam flows or other material flows, or any other aspects of the thermodynamic power generation system 102 that may be controlled.

As described in more detail below, setpoints or other parameters used by the thermodynamic control system 108 may be generated using one or more machine learning models. For instance, the one or more machine learning models may be used to predict and optimize power generation by the thermodynamic power generation components 104. These machine learning models can be generated and used by other components of the system 100. In this example, for instance, the system 100 also includes one or more user devices 110a-110d, one or more networks 112, one or more application servers 114, and one or more database servers 116 associated with one or more databases 118 and/or one or more file servers 120. Each user device 110a-110d communicates over the network 112, such as via a wired or wireless connection. Each user device 110a-110d represents any suitable device or system used by at least one user to provide or receive information, such as a desktop computer, a laptop computer, a smartphone, and a tablet computer. However, any other or additional types of user devices may be used in the system 100.

The network 112 facilitates communication between various components of the system 100. For example, the network 112 may communicate Internet Protocol (IP) packets, frame relay frames, Asynchronous Transfer Mode (ATM) cells, or other suitable information between network addresses. The network 112 may include one or more local area networks (LANs), metropolitan area networks (MANs), wide area networks (WANs), all or a portion of a global network such as the Internet, or any other communication system or systems at one or more locations. In some cases, the network 112 may include at least one network within or associated with a facility operator that uses one or more machine learning models to perform one or more functions.

The application server 114 is coupled to the network 112 and is coupled to or otherwise communicates with the database server 116 and/or file server 120. The application server 114 and the database server 116, database 118, and/or file server 120 support the generation of one or more machine learning models 122 for use by the application server 114 in controlling the thermodynamic power generation system 102. For example, the application server 114 may execute one or more applications used to define the architecture of a machine learning model 122 and to train the machine learning model 122 based on suitable training data. In some cases, for instance, the database 118 and/or the file server 120 may be used to store training data, and the application server 114 can use the training data to train and validate each machine learning model 122 prior to deployment/use of the machine learning model 122 (such as prior to deployment of the machine learning model 122 for use in controlling the thermodynamic power generation system 102). Note, however, that the database server 116 or file server 120 may also be used within the application server 114 to store information, in which case the application server 114 itself may store information used to support machine learning-based optimization of thermodynamic power generation.

The database server 116 and/or the file server 120 operates to store and facilitate retrieval of various information used, generated, or collected by the application server 114 and the user devices 110a-110d. For example, the database server 116 and/or the file server 120 may store data associated with operation of the thermodynamic power generation system 102 over time. As a particular example, the database server 116 and/or the file server 120 may store data associated with measurements captured by the thermodynamic sensors 106 (or information derived therefrom), control signals generated by the thermodynamic control system 108, or other information associated with operation of the thermodynamic power generation system 102 over time. In some cases, this may encompass information associated with operation of the thermodynamic power generation system 102 over a prolonged period of time, such as when one or more years’ worth of data related to the operation of the thermodynamic power generation system 102 is stored in the database 118 and/or the file server 120.

In some embodiments, the thermodynamic control system 108 and the application server 114 can operate in real-time. For example, the application server 114 may receive real-time measurements or other information from the thermodynamic sensors 106 or the thermodynamic control system 108 and process the measurements or other information using one or more machine learning models in real-time to determine how to optimize flows of steam or other material to or from the thermodynamic power generation components 104. The application server 114 can then provide one or more control instructions to the thermodynamic control system 108, which can generate control signals or otherwise implement an optimization strategy in order to control the flows of steam or other material to the thermodynamic power generation components 104. In other embodiments, the thermodynamic control system 108 can operate in real-time to maintain control over the thermodynamic power generation components 104, while the application server 114 may operate in an offline manner in order to process data and determine suitable control instructions for the thermodynamic control system 108. This may allow, for instance, the application server 114 to change setpoints or other operations of the thermodynamic control system 108 less frequently. Note that in either case, the application server 114 may perform one or more offline analyses to support control over the thermodynamic power generation system 102. Some example types of offline analyses may include studying scenarios of how the thermodynamic power generation system 102 could be configured, auditing analyses of recent historical time-series data, and performing parametric analyses to determine safety and environmental risks.

In whatever manner the thermodynamic power generation system 102 is controlled, the application server 114 may operate to ideally increase power generation or achieve one or more other or additional goals involving the thermodynamic power generation system 102. Note, however, that other components of the system 100 may use one or more machine learning models to predict and optimize power generation by the thermodynamic power generation components 104 or meet some other goal(s), and information based on control optimization guidance can be generated by or provided to the thermodynamic control system 108 for use in implementing the control optimization guidance.

The application server 114 here may have a direct or indirect connection with the control system 108 or other component(s) of the thermodynamic power generation system 102. An indirect connection with the control system 108 may be created in any suitable manner, such as via a public or other network 124. For example, in some embodiments, the application server 114 could be implemented within the thermodynamic power generation system 102 itself, in which case the application server 114 may have a direct connection to the control system 108 or may communicate with the control system 108 via a local private network 124. In other embodiments, the application server 114 could be implemented outside the thermodynamic power generation system 102, in which case the application server 114 may communicate with the control system 108 via at least one network 124 (such as a public network like the Internet and a local private network).

Although FIGURE 1illustrates one example of a system 100 supporting machine learning-based optimization of thermodynamic power generation, various changes may be made to FIG. 1. For example, the thermodynamic power generation system 102 may include any suitable numbers and arrangements of thermodynamic power generation components 104, thermodynamic sensors 106, and thermodynamic control systems 108. Also, the system 100 may include any suitable number of user devices 110a-110d, networks 112, 124, application servers 114, database servers 116, databases 118, and file servers 120. Further, these components may be located in any suitable locations and might be distributed over a large area. In addition, while FIG. 1 illustrates one example operational environment in which machine learning-based optimization of thermodynamic power generation may be used, this functionality may be used in any other suitable system.

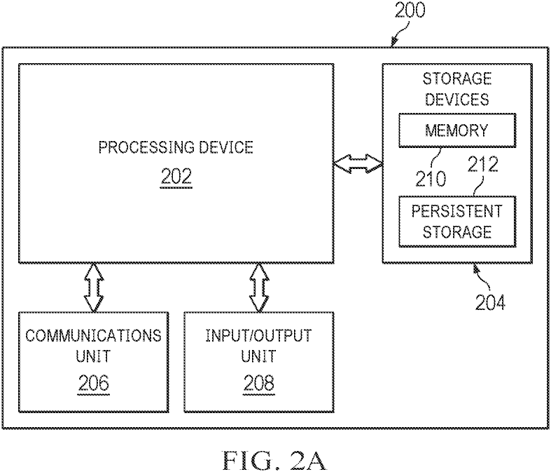

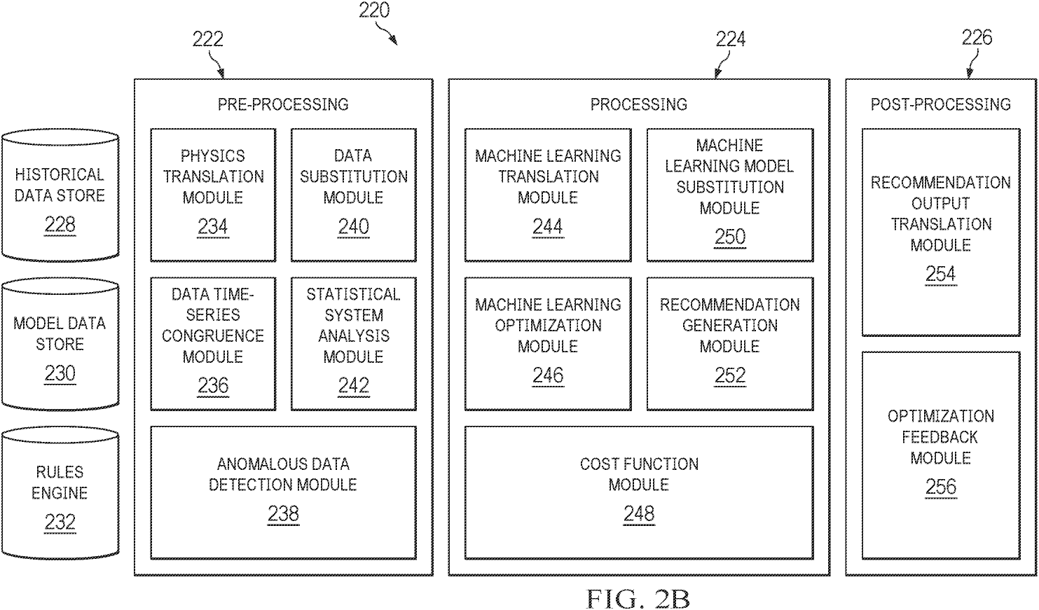

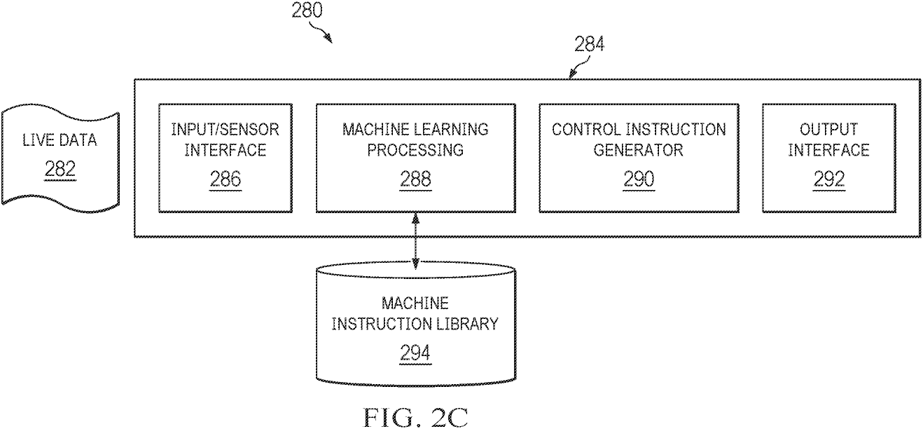

FIGS. 2A through 2C illustrate an example device 200 and related details supporting machine learning-based optimization of thermodynamic power generation according to this disclosure. One or more instances of the device 200 may, for example, be used to at least partially implement the functionality of the application server 114 or the thermodynamic control system 108 in the system 100 of FIG. 1. However, the functionality of the application server 114 or the thermodynamic control system 108 may be implemented in any other suitable manner.

As shown in FIG. 2A, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (OPUs), cerebras wafer-scale engines (WSEs), digital signal processors (DSPs), application-specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over at least one physical or wireless network, such as the network(s) 112, 124 or a process control network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

As shown in FIG. 2B, a functional architecture 220 represents various functions or functional modules that may be implemented by the device 200, another implementation of the application server 114, or another device or system that implements the functionality of the application server 114 described in this disclosure. For example, the functional architecture 220 may represent a software architecture for a software application or software package executed by the processing device(s) 202 of the device 200 or application server 114. As can be seen in FIG. 2B, the functional architecture 220 is generally divided into three stages of functions or functional modules, namely a pre-processing stage 222, a processing stage 224, and a post-processing stage 226. The pre-processing stage 222 generally represents functions or functional modules related to pre-processing of data used by or otherwise associated with machine learning models. The processing stage 224 generally represents functions or functional modules related to processing of data by the machine learning models and the generation of possible recommendations or other outputs by the machine learning models. The post-processing stage 226 generally represents functions or functional modules related to processing of the recommendations or other outputs generated by the machine learning models.

The functional architecture 220 here includes or is used in conjunction with one or more data stores 228-232. For example, the data store 228 may represent a historical data store that is used to store data related to operations of the thermodynamic power generation system 102 over time, such as sensor data from various thermodynamic sensors 106 (like flow, temperature, and pressure measurements), control signals generated by the thermodynamic control system 108, and/or calculated metrics (like enthalpy and entropy metrics). The data store 230 may represent a machine learning model data store that is used to store data related to the machine learning models 122, such as coefficients defined for the machine learning models 122 during linear regression or other analyses. The data store 232 may represent a rules engine data store that is used to store data related to rules that are enforced during one or more of the stages shown here. Each data store 228-232 includes any suitable structure configured to store and facilitate retrieval of information. For instance, in some cases, the data stores 228-232 may represent a common data store, such as the database 118 or file server 120. In other cases, two or more of the data stores 228-232 may represent different data stores, such as different databases 118 or different file servers 120.

The pre-processing stage 222 in this example includes a physics translation module 234, a data time-series congruence module 236, an anomalous data detection module 238, a data substitution module 240, and a statistical system analysis module 242. The physics translation module 234 generally operates to receive or otherwise obtain historical data and prepare the data for use in training one or more machine learning models 122. For example, the physics translation module 234 may obtain information (such as from various thermodynamic sensors 106 or other sources) identifying flows of material to or from the thermodynamic power generation components 104 and power generated by the thermodynamic power generation components 104 (individually or collectively). The physics translation module 234 may also obtain other data related to the operation of the thermodynamic power generation components 104, such as pressures, temperatures, flow rates, or other data collected within the thermodynamic power generation system 102. In addition, the physics translation module 234 can associate one or more aspects of the operation of the thermodynamic power generation system 102 (such as the flows of material) with the power being generated in order to make an initial determination of which data related to the thermodynamic power generation system 102 influences or has an effect on the amount of power generated. The physics translation module 234 here is effectively obtaining data that will be used to train one or more machine learning models 122 to predict power generation based on the flows of material to or from the thermodynamic power generation components 104.

The data time-series congruence module 236 generally operates to analyze the incoming data and identify which portions of the data are or are not consistent with one another. As an example, the data time-series congruence module 236 may compare the total input flow(s) of material into each thermodynamic power generation component 104 and the total output flow(s) of material from each thermodynamic power generation component 104 in order to determine whether the totals match (at least to within a threshold amount or percentage of accuracy). The anomalous data detection module 238 generally operates to perform “bad data” detection in order to identify any of the incoming data that might be erroneous, unreliable, unusable, or otherwise invalid. For instance, the anomalous data detection module 238 may use the results from the data time-series congruence module 236 and identify which data (identified as being inconsistent with other data) might be excluded from subsequent use.

The data time-series congruence module 236 and the anomalous data detection module 238 may perform any suitable analyses in order to determine whether incoming data is consistent and to identify data that is considered “bad” or that is otherwise to be excluded. In some cases, one or more rules in the data store 232 may be used to define how incoming data is analyzed in order to determine whether the incoming data is consistent. Similarly, one or more rules in the data store 232 may be used to define when incoming data is considered bad. In other cases, the data time-series congruence module 236, the anomalous data detection module 238, or both may be implemented using at least one machine learning model that has been trained to recognize inconsistent data, bad data, or both. In still other cases, the data time-series congruence module 236, the anomalous data detection module 238, or both may use statistical analysis, engineering analysis, or both to recognize inconsistent data, bad data, or both. Statistical analysis typically focuses on analyzing data to identify specific statistics that might be indicative of inconsistent or bad data, while engineering analysis typically focuses on analyzing data associated with a facility based on the layout and arrangement of the facility to identify indicators of inconsistent or bad data. Any combination of the above approaches may also be used to determine whether incoming data is inconsistent, bad, or both.

The data substitution module 240 generally operates to select replacement data that may be used in place of data identified as being bad or otherwise unusable by the anomalous data detection module 238. For example, the data substitution module 240 may perform a classification function in order to classify at least one type of data that is unusable. As a particular example, the data substitution module 240 may determine whether unusable data represents continuous measurements of a variable or values of a control signal generated by the control system 108. Based on the classification, the data substitution module 240 may also impute data values that could be used in place of the unusable data. As particular examples, the data substitution module 240 may determine that average or most frequent values contained in known good data for a variable or a known good control signal might be used in place of the bad data for that variable or control signal. The data substitution module 240 can further impose boundaries on data values, such as upper and lower bounds that are based on historical or engineering analysis of the thermodynamic power generation system 102. If possible, the data substitution module 240 may identify one or more “proxy” variables or calculations to be used in place of the bad data. For instance, if a steam flow sensor appears to be providing incorrect or erroneous flow measurements regarding a flow of steam to or from a thermodynamic power generation component 104, the data substitution module 240 may be able to determine that a water flow into a boiler producing the steam could be used to calculate a metric in place of the steam flow measurement.

The data substitution module 240 may perform any suitable analyses in order to determine how bad data associated with a thermodynamic power generation system 102 can be handled. In some cases, one or more rules in the data store 232 may be used to define how bad data associated with the thermodynamic power generation system 102 can be handled. In other cases, the data substitution module 240 may be implemented using at least one machine learning model that has been trained to classify unusable data and identify potential replacement data values or proxy data for the unusable data.

The statistical system analysis module 242 may be used to perform various statistical analyses of data in order to support one or more other modules in the pre-processing stage 222. For example, the statistical system analysis module 242 may generate histograms identifying data distributions in different datasets, identify average or median values of different datasets, identify most-frequent values contained in different datasets, or perform other analyses. Statistics related to historical data generated by the statistical system analysis module 242 may also be used by other stages 224, 226, such as when the data distributions for historical data are useful in analyzing the performance of machine learning models 122 or other data generated by the processing stage 224. The statistical system analysis module 242 may be configured to perform any suitable statistical analyses as needed or desired.

The processing stage 224 in this example includes a machine learning translation module 244, a machine learning optimization module 246, a cost function module 248, a machine learning substitution module 250, and a recommendation generation module 252. The machine learning translation module 244 generally operates to take pre-processed data from the pre-processing stage 222 and use the data to perform machine learning model training. For example, the machine learning translation module 244 may use the pre-processed data from the pre-processing stage 222 to perform various regression analyses (such as linear regression analyses) or other analyses in order to generate one or more machine learning models 122 representing power generation by the thermodynamic power generation components 104. Example types of regression analyses that might be performed could include a linear regression analysis, a dummy regression analysis, or a linear regression analysis with quadratic terms. If information indicates that a previously-trained machine learning model 122 may be unreliable or is providing less-than-desirable results (such as based on information from the statistical system analysis module 242 or feedback information from the post-processing stage 226), the machine learning translation module 244 may be used to train a new machine learning model 122 or retrain an existing machine learning model 122. This may allow, for instance, the machine learning translation module 244 to replace a machine learning model 122 that is unreliable or otherwise not operating as desired. In some cases, the machine learning translation module 244 can output linear regression coefficients or other coefficients defining each machine learning model 122 that is generated, where the coefficients can be used during optimization.

The machine learning optimization module 246 performs actual optimization calculations in order to identify a solution to an optimization problem. The optimization problem is defined by or associated with an objective function, where the objective function can be maximized or minimized to achieve one or more desired results. Example results may include, for instance, maximizing power production, minimizing environmental emissions, identifying optimum steam flows or other material flows to support heat requirements in a facility, identifying optimum routings of associated steam or other material flows, identifying optimum disposition of waste streams, and minimizing cost of fuel and supporting chemicals. In some cases, the machine learning optimization module 246 can use or be implemented using a mathematical solver (such as a GUROBI optimizer) in order to identify an optimization solution that maximizes or minimizes the objective function, and the optimization solution can represent control optimization guidance. The control optimization guidance represents information that can be used as at least one control instruction or that can be used to generate at least one control instruction, where the at least one control instruction may be used to modify or control the operation of the thermodynamic power generation system 102.

In some cases, the machine learning optimization module 246 may use one or more slack variables in the objective function, where the one or more slack variables can be added to the objection function in order to allow a small level of mismatch between certain constraints and to increase the flexibility of the optimization performed by the machine learning optimization module 246. For example, precision measurements may be difficult or impossible to obtain across all timestamps in which the thermodynamic power generation system 102 is operating. This may be due to a number of factors, such as one or more faulty sensors 106 or other faulty equipment The one or more slack variables can be added to the objection function in order to account for these issues. However, it may be undesirable to allow the machine learning optimization module 246 to use the slack variable(s) in certain ways, since the machine learning optimization module 246 could use the slack variable(s) to make adjustments that are not actually feasible. The cost function module 248 can be used to apply a penalty to the usage of the one or more slack variables, and this penalty can help to reduce or prevent the machine learning optimization module 246 from using the slack provided by the slack variable(s) in an undesirable manner when performing optimization.

The machine learning substitution module 250 generally operates to support the usage of different machine learning models 122 for the same thermodynamic power generation component 104 over time. For example, power generation by a single thermodynamic power generation component 104 or a single collection of thermodynamic power generation components 104 may be modeled using different machine learning models 122 generated by the machine learning translation module 244. The machine learning substitution module 250 may select which specific machine learning model 122 is to be used at any given time in order to predict the power generation by the associated thermodynamic power generation component(s) 104. As a particular example, the machine learning substitution module 250 may monitor actual power generation by one or more thermodynamic power generation components 104 (such as based on data obtained from the control system 108 or the statistical system analysis module 242) and compare predictions of the power generation produced using the associated machine learning model(s) 122 with the actual power generation. If the error between the actual power generation and the predicted power generation is excessive (such as when the error exceeds a specified threshold amount or percentage), the machine learning substitution module 250 may select a different machine learning model 122 for use. In a similar manner, the machine learning substitution module 250 may use the error between actual and predicted power generation to determine if a new machine learning model 122 should be generated by the machine learning translation module 244 or if the machine learning translation module 244 should perform retraining of an existing machine learning model 122. Note that the analysis of each machine learning model’s accuracy may be performed in any suitable manner, such as in a continuous manner, periodically (such as daily or weekly), or at any other suitable time(s).

The recommendation generation module 252 takes the outputs from the machine learning optimization module 246 and converts those outputs into possible recommendations that may be implemented within the thermodynamic power generation system 102. For example, the machine learning optimization module 246 can generate predictions about what the flows of steam or other material to the thermodynamic power generation components 104 might be in order to maximize power production by the thermodynamic power generation components 104 or to achieve some other result(s). The recommendation generation module 252 can take those predictions and translate the predictions into desired flow rates of materials to the thermodynamic power generation components 104.

The post-processing stage 226 in this example includes a recommendation output translation module 254 and an optimization feedback module 256. The recommendation output translation module 254 generally operates to take the recommendations provided by the recommendation generation module 252 and convert those recommendations into actions that may be implemented within the thermodynamic power generation system 102. For example, in some cases, the recommendations from the recommendation generation module 252 may take the form of desired flows of material to or from the thermodynamic power generation components 104, and the recommendation output translation module 254 can translate these flows into setpoints or other values for use by valves or other equipment in the thermodynamic power generation system 102. Depending on the thermodynamic power generation system 102, the actual recommendations produced by the recommendation output translation module 254 can vary. For instance, when the thermodynamic power generation components 104 use flows of steam or other material to generate electrical energy, the actual recommendations may include setpoints for valves controlling the flows, pressures of the flows, feedstocks or catalysts used to produce the flows, or products being produced (during production of the flows).

The optimization feedback module 256 can provide information back to other components of the functional architecture 220 based on whether recommendations produced by the functional architecture 220 are accepted or rejected (such as by one or more users of the system 100). For example, the optimization feedback module 256 may detect when a specific recommendation is rejected by a user, and the optimization feedback module 256 can feed back information to the processing stage 224 indicating that the specific recommendation was not accepted by the user. This can be useful information during subsequent model training/retraining. The optimization feedback module 256 may also perform functions like boundary checking to verify whether each particular recommendation produced by the recommendation output translation module 254 is within specified bounds. If not, the optimization feedback module 256 can prevent a particular recommendation from being presented to users or implemented, and the optimization feedback module 256 can feed back information to the processing stage 224 indicating that the particular recommendation was erroneous. Again, this can be useful information during subsequent model training/retraining.

As shown in FIG. 2C, an operational flow 280 related to usage of the functional architecture 220 is shown. As can be seen here, live data 282 is received or otherwise obtained, such as when the control system 108 provides data to the application server 114. The live data 282 can represent or include current operational data associated with operation of the thermodynamic power generation system 102. A group 284 of components in FIG. 2C represents broad overall types of components within the application server 114 or other device 200. As shown here, the components include an input/sensor interface 286, which can receive the live data 282. The input/sensor interface 286 may allow the application server 114 to receive the live data 282 directly from the thermodynamic sensors 106 or indirectly, such as via the control system 108. In particular embodiments, the input/sensor interface 286 may represent a communications unit 206 described above with reference to FIG. 2A.

Machine learning processing 288 here represents various analyses of the live data 282 by the application server 114. For example, the machine learning processing 288 may represent or be implemented using the functional architecture 220 shown in FIG. 2B. That is, the machine learning processing 288 may perform the various functions of the functional architecture 220 in order to process the live data 282 and generate recommendations based on the live data 282. In particular embodiments, the machine learning processing 288 may be implemented using software/firmware instructions stored in the storage device(s) 204 and executed by the processing device(s) 202 described above with reference to FIG. 2A.

A control instruction generator 290 uses outputs of the machine learning processing 288 to generate actual control instructions for the control system 108 or for actuators or other components in the thermodynamic power generation system 102. For example, the control instruction generator 290 may receive an identification of recommendations that have been approved by at least one user, and the control instruction generator 290 may generate commands to the control system 108 for implementing the approved recommendations. As particular examples, the control instruction generator 290 may generate commands to the control system 108 for implementing changes to valve setpoints or other setpoints used by the control system 108 when controlling the thermodynamic power generation system 102. In particular embodiments, the control instruction generator 290 may be implemented using software/firmware instructions stored in the storage device(s) 204 and executed by the processing device(s) 202 described above with reference to FIG. 2A. The control instructions can be output to the control system 108 or other suitable destination(s) via at least one output interface 292. In particular embodiments, the output interface 292 may represent a communications unit 206 described above with reference to FIG. 2A.

In some embodiments, a machine instruction library 294 may be used to store machine learning logic implemented by the application server 114. For instance, the machine instruction library 294 may include one or more of the data stores 228-232 described above, as well as machine-readable instructions that implement the functionalities of the pre-processing stage 222, the processing stage 224, and the post-processing stage 226. In some cases, the machine instruction library 294 may be stored in the database 118 or the file server 120 or the storage device(s) 204.

Although FIGS. 2A through 2C illustrate one example of a device 200 and related details supporting machine learning-based optimization of thermodynamic power generation, various changes may be made to FIGS. 2A through 2C. For example, computing and communication devices and systems come in a wide variety of configurations, and FIGS. 2A through 2C do not limit this disclosure to any particular computing or communication device or system. Also, various functions/modules/components can be added, omitted, combined, further subdivided, replicated, or placed in any other suitable configuration within the functional architecture 220 or the operational flow 280 as needed or desired. In addition, while the device 200, functional architecture 220, and operational flow 280 are described as being used to support machine learning-based optimization of thermodynamic power generation, the device 200, functional architecture 220, and operational flow 280 may be used to support machine learning-based optimization of other processes.

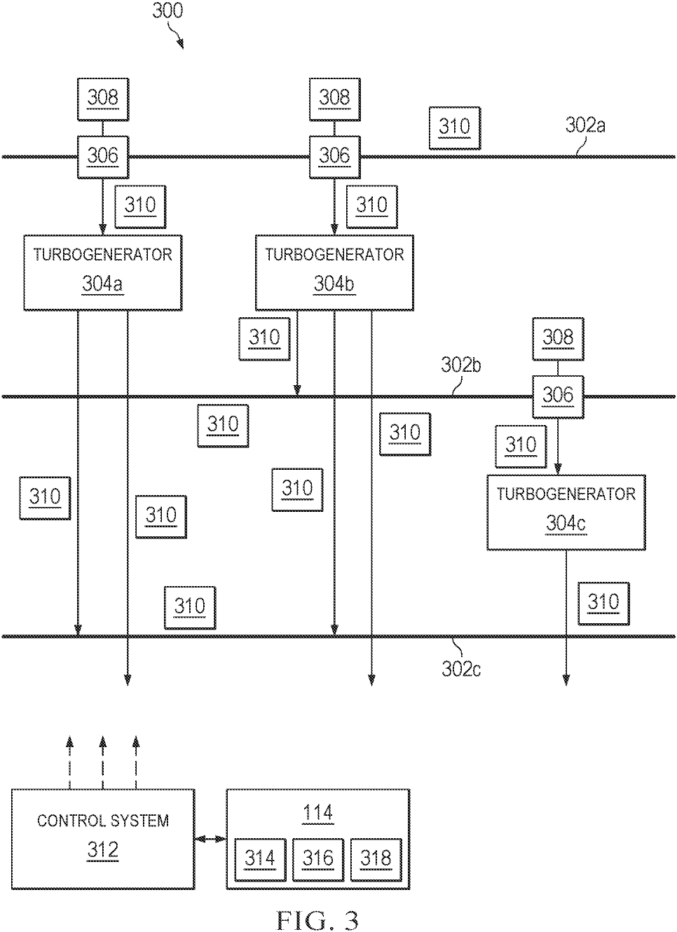

FIG. 3 illustrates an example thermodynamic power generation system 300 according to this disclosure. The thermodynamic power generation system 300 shown in FIG. 3 may, for example, represent or be used to at least partially implement the functionality of the thermodynamic power generation system 102 shown in FIG. 1 and described above. However, the thermodynamic power generation system 102 shown in FIG. 1 may be implemented in any other suitable manner.

As shown in FIG. 3, the thermodynamic power generation system 300 includes multiple steam headers 302a-302c. In general, each steam header 302a-302c represents a pipe or other structure configured to hold and allow transport of steam within a specified pressure range. For example, the steam header 302a may represent a higher-pressure steam header and hold steam at higher pressures, the steam header 302b may represent a medium-pressure steam header and hold steam at medium pressures (less than the higher pressures), and the steam header 302c may represent a lower-pressure steam header and hold steam at lower pressures (less than the medium pressures). In this example, there are three steam headers 302a-302c, although the thermodynamic power generation system 300 may include two steam headers or more than three steam headers. At least two of the steam headers in the thermodynamic power generation system 300 contain steam having a pressure differential that is suitable for power generation.

The thermodynamic power generation system 300 also includes multiple turbogenerators 304a-304c, which may represent specific implementations of the thermodynamic power generation components 104. In general, each turbogenerator 304a-304c represents a structure configured to reduce the pressure of steam while generating electrical power. In this example, there are three turbogenerators 304a-304c, although the thermodynamic power generation system 300 may include two turbogenerators or more than three turbogenerators. Each turbogenerator 304a-304c may receive steam at any suitable pressure and reduce the pressure of the steam to any other suitable pressure. In FIG. 3, for instance, the turbogenerator 304a receives the higher-pressure steam from the steam header 302a and produces lower-pressure steam that is provided to the steam header 302c or output from the thermodynamic power generation system 300. The turbogenerator 304b receives the higher-pressure steam from the steam header 302a, produces medium-pressure steam that is provided to the steam header 302b, and produces lower-pressure steam that is provided to the steam header 302c or output from the thermodynamic power generation system 300. The turbogenerator 304c receives the medium-pressure steam from the steam header 302b and produces lower-pressure steam that is output from the thermodynamic power generation system 300. Note, however, that these three specific configurations of the turbogenerators 304a-304c are for illustration only, and the thermodynamic power generation system 300 may include turbogenerators each having any suitable configuration.

Each turbogenerator 304a-304c can be fed steam via an associated valve 306, and each valve 306 can be controlled by an associated actuator 308. The valves 306 can be adjusted in order to provide controllable flows of steam to the turbogenerators 304a-304c. In some cases, the valves 306 are adjusted in order to increase or maximize the amount of electrical power produced by the turbogenerators 304a-304c. However, other suitable optimization goals may be supported in the thermodynamic power generation system 300, and/or other suitable components can be controlled to achieve one or more goals. Each valve 306 represents any suitable structure configured to control a flow of steam. Each actuator 308 represents any suitable structure configured to control or adjust the opening provided by a valve 306.

Various sensors 310 may be provided within the thermodynamic power generation system 300. The sensors 310 may represent specific implementations of the thermodynamic sensors 106. The sensors 310 can be used to measure one or more characteristics within the thermodynamic power generation system 300. For example, sensors 310 may be used to measure steam pressure, temperature, flow rate, or other or additional characteristics (or any combination thereof) of steam within the steam headers 302a-302c or turbogenerators 304a-304c. Sensors 310 may also or alternatively be used to measure other characteristics of components within the thermodynamic power generation system 300. In this example, the sensors 310 are shown in association with the steam headers 302a-302c and with the various steam flows into and out of the turbogenerators 304a-304c, although the actual positions of the sensors 310 and the characteristics measured by the sensors 310 can vary. Each sensor 310 includes any suitable structure configured to measure one or more characteristics within a facility.

A control system 312 is provided within or in association with the thermodynamic power generation system 300. The control system 312 may represent a specific implementation of the thermodynamic control system 108. The control system 312 is configured to control the valves 306, turbogenerators 304a-304c, or other components of the thermodynamic power generation system 300. For example, the control system 312 may receive input from the application server 114, such as in the form of one or more control instructions. The control system 312 may adjust operations of the valves 306 or other components of the thermodynamic power generation system 300 based on the one or more control instructions.

The application server 114 here may analyze measurement data from the sensors 310 or other data in order to optimize the flows of steam to or from the turbogenerators 304a-304c. In some cases, for example, the application server 114 may generate operational setpoints, such as positions of the valves 306 that achieve increased or maximum power generation or satisfy one or more other criteria. The operational setpoints may be provided to one or more human personnel for review, approval, and implementation. The operational setpoints may also or alternatively be provided to the control system 312 for use in automatically adjusting the positions of the valves 306, such as after approval by the human personnel.

The application server 114 includes or has access to one or more machine learning models 314 that represent or model power generated by the turbogenerators 304a-304c. The machine learning models 314 may represent specific implementations of the machine learning models 122. Depending on the implementation, each turbogenerator 304a-304c may have its own associated machine learning model 314, or some combination or all of the turbogenerators 304a-304c may be associated with a common machine learning model 314. The application server 114 can receive input data (such as from the control system 312), pre-process the input data, and provide the pre-processed input data to the one or more machine learning models 314 for analysis. The one or more machine learning models 314 can be used to predict the power generated by the turbogenerators 304a-304c (individually or collectively). In some cases, the input data provided to the one or more machine learning models 314 may only include information regarding flows of steam into and/or out of each turbogenerator 304a-304c. In other cases, the input data provided to the one or more machine learning models 314 may include information regarding flows of steam into and/or out of each turbogenerator 304a-304c and other input data, such as temperature, pressure, specific enthalpy, specific entropy, or steam quality.

The one or more machine learning models 314 may be trained to predict power generation by turbogenerators 304a-304c in any suitable manner. For example, the one or more machine learning models 314 may be designed as linear regression models produced using at least one regression algorithm, where the linear regression models use input and extraction flows of the turbogenerators 304a-304c as independent variables. The one or more machine learning models 314 can be trained as described above with reference to the machine learning translation module 244 of FIG. 2B. The one or more machine learning models 314 can be adjusted to be more generalized, such as by tuning hyperparameters for Lasso or Ridge regression or other suitable techniques, to identify power generation predictions based on input and extraction flow measurements. As noted above, however, machine learning models that use other or additional input data may also be used, in which case the machine learning models may be generated in any other suitable manner.

The application server 114 also includes or has access to an optimizer 316. The optimizer 316 generally represents an algorithm or other logic that can process data (including power generation predictions from the one or more machine learning models 314) in order to generate optimization solutions representing control optimization guidance. The optimizer 316 may be implemented as described above with reference to the machine learning optimization module 246 of FIG. 2B. Each optimization solution can identify a configuration of the thermodynamic power generation system 300, such as a configuration of valve settings or other settings to control how steam or other material is provided to the turbogenerators 304a-304c or other thermodynamic power generation components 104. For example, an optimization solution may identify desired flows of steam or other material to or from the turbogenerators 304a-304c that would obtain some type of specified result, such as improved or maximized power production by the turbogenerators 304a-304c. As a particular example, an optimization solution may identify (or may be used to identify) desired positions for the valves 306 that would obtain some type of specified result, such as improved or maximized power production by the turbogenerators 304a-304c. The optimizer 316 is typically used to solve an optimization problem, where (as noted above) the optimization problem can be defined by or associated with an objective function and where the objective function can be maximized or minimized to achieve the desired result(s). Various optimizers 316 are known in the art, and many are sure to be developed in the future. Any suitable optimizer 316 may be used here to generate optimization solutions or other control optimization guidance. As a particular example, a mathematical solver (such as a GUROBI optimizer) may be used here.

In some cases, the objective function that is used by the optimizer 316 can be expressed in terms of maximizing the power collectively generated by the turbogenerators 304a-304c. Each optimization solution that is generated by the optimizer 316 using such an objective function can therefore ideally be used to increase or maximize the power collectively generated by the turbogenerators 304a-304c. In some embodiments, the objective function includes multiple optimization variables, where the optimization variables include the steam flows provided to or received from the turbogenerators 304a-304c via the valves 306a-306c. When the one or more machine learning models 314 are produced using regression, the steam flows provided to or received from the turbogenerators 304a-304c may represent the independent variables used to model the turbogenerators 304a-304c by the one or more machine learning models 314.

The optimizer 316 also enforces constraints associated with the thermodynamic power generation system 300 when generating the optimization solutions, such as when the optimizer 316 does not identify optimization solutions having steam flow rates exceeding maximum flow rates. As described below, the optimizer 316 can be designed to use realistic constraints of the thermodynamic power generation system 300 that are based on historical data, rather than theoretical constraints that are often not achievable in real-world systems. Also, as described below, some characteristics of the thermodynamic power generation system 300 may not be measured (referred to as “unmetered” characteristics), such as due to the lack of one or more sensors 310 for measuring that characteristic. The application server 114 may therefore determine one or more unmetered characteristics or treat one or more unmetered characteristics as optimization variables that can fluctuate based on other variables. The use of real-world constraints and the consideration of one or more unmetered characteristics can help to improve the optimization solutions produced by the optimizer 316, and the optimizer 316 can arrive at feasible solutions more often.

The control system 312 includes any suitable structure configured to control a steam system. For example, the control system 312 may include one or more computing devices, an example of which is described above with reference to FIG. 2A. Additional operations of the overall thermodynamic power generation system 300 in general and the application server 114 specifically are provided below. In some embodiments, the application server 114 includes an interface module 318 that is operatively coupled to the machine learning model(s) 314 and the optimizer 316. The interface module 318 may be used to remotely manage communications (such as for sending and receiving data, orchestrating sensor data, scheduling, etc.) with the machine learning model(s) 314 and the optimizer 316.

Note that the example thermodynamic power generation system 300 shown in FIG. 3 has been simplified for ease of explanation. A steam system may include numerous components spread across a wide area, and any number of components can be added to FIG. 3 as needed or desired. Also, steam systems that can be optimized according to this disclosure may find use in a wide variety of applications. Example applications may include use with cogeneration systems in manufacturing plants or other facilities, district or municipal heating systems, military bases that have steam systems, or other steam systems. In addition, note that while the use of steam-based turbogenerators 304a-304c is described here, the thermodynamic power generation system 300 may include one or more other or additional types of power generation devices, such as one or more gas-driven turbines. When one or more other or additional types of power generation devices are present in the thermodynamic power generation system 300, the optimizer 316 may be configured to optimize power generation collectively for the entire thermodynamic power generation system 300, possibly including (but not limited to) the power generated using the turbogenerators 304a-304c.

Although FIG. 3 illustrates one example of a thermodynamic power generation system 300, various changes may be made to FIG. 3. For example, components can be added, omitted, combined, further subdivided, replicated, or placed in any other suitable configuration in the thermodynamic power generation system 300 according to particular needs. Also, all or any subset of the features shown in or described with respect to FIG. 3 may be used with any other suitable thermodynamic power generation system, such as the thermodynamic power generation system 102 of FIG. 1.

As noted above, in some cases, machine learning-based optimization of thermodynamic power generation may be used in conjunction with at least one manufacturing plant or other plant. A “process facility” generally refers to a facility or a portion thereof that produces at least one tangible output or finished good. Many process facilities include at least one steam generation component because steam has a wide range of applications, such as heating, propulsion, atomization, cleaning, moisturization, or humidification. In the case of using steam for propulsion (as a driving force), a common application is to drive steam turbogenerators for power generation. The efficiency of converting steam into power can be important because, by recycling energy, facilities can both reduce their environmental footprint and save money. Similar arrangements and benefits can be obtained using other arrangements of thermodynamic power generation components. Process facilities tend to be extremely large and can have hundreds or thousands of physical assets and components that work in conjunction under process engineers’ control. However, due to the data-dense environment, process engineers are often unable to make decisions that optimize power generated by turbogenerators or other thermodynamic power generation components at these facilities while also satisfying physical plant constraints and demands.

Process facilities that use steam typically run in either steam excess mode or steam deficit mode, meaning the facilities are producing too much steam or too little steam. Steam balance leads to optimal thermal efficiencies and performance in a process facility. Therefore, steam balance can be the first step or at least an important step in a steam system optimization and management program. The approaches described above and below in this patent document provide a combination of physics-driven machine learning and optimization, which is used to provide substantial steam balance or other material balance and to increase or maximize power generation from turbogenerators or other thermodynamic power generation components. The described approaches carefully follow first-principles physics laws, such as mass balance and conservation. The described approaches also uphold historical and manufacturer limits on a process facility, such as to ensure feasible control optimization guidance is generated. In some embodiments, the described approaches can be used to provide process engineers or other personnel with operational setpoints or other information that achieve increased or maximized power generation at a facility without impacting production. In other embodiments, the described approaches can be used to generate operational setpoints or other control instructions that are implemented automatically by a control system.

Current approaches for steam system optimization often use mathematical programming. However, industrial and other process facility operations can be very complex and include different steam or other material producers, different pressure and temperature requirements, and different time-varying steam or other material consumptions. With time-specific components and demands, steam balance or other material balance is not a one-time optimization and instead requires a dynamic solution. Because of this, there are often major shortcomings with prior approaches for steam system optimization. For example, many current approaches rely on theoretical physics equations to predict power, efficiency, and other dependent variables. However, the imprecision of sensor data can make these theoretical physics equations inaccurate, rendering those approaches unreliable.

The novel approaches provided in this disclosure use one or more data-driven machine learning models 122, 314. For example, one or more machine learning models 122, 314 may be trained and used to predict the power generated by multiple turbogenerators 304a-304c or other thermodynamic power generation components 104 in a facility over time. In some cases, each machine learning model 122, 314 can be trained to predict the power generated by at least one turbogenerator 304a-304c or other thermodynamic power generation component 104 based on specific input data, such as at least one input steam flow or other material flow provided to the at least one turbogenerator 304a-304c or other thermodynamic power generation component 104. In particular embodiments, the one or more machine learning models 122, 314 can be implemented as linear regression models, where inlet and extraction flows are used as independent variables. Here, the inlet flow refers to the input stream(s) of steam or other material to at least one turbogenerator 304a-304c or other thermodynamic power generation component 104, and the extraction flow refers to the output stream(s) of steam or other material received from the at least one turbogenerator 304a-304c or other thermodynamic power generation component 104.

By using machine learning rather than rigid theoretical physics equations, the one or more machine learning models 122, 314 can be trained to predict power generation of turbogenerators 304a-304c or other thermodynamic power generation components 104 with sufficiently low errors. As a result, thermodynamic power generation optimization becomes feasible based on the power generation predictions produced by the one or more machine learning models 122, 314. For instance, coefficients produced using linear regression or other machine learning analyses can be plugged directly into an optimizer’s objective function and used for optimization.

Moreover, many current approaches rely on a process facility’s designated theoretical limits, such as maximum flow rates of steam through valves and steam headers. However, this disclosure recognizes that, for data like sensor measurements (such as measurements of flow rates through valves 306 and steam headers 302a-302c), the minimum and maximum values of historical sensor data typically do not adhere to a facility’s designated theoretical limits. Real historical values tend to be smaller than stated limits, which could be due to general deterioration of pipes and the use of materials that reduce maximal flows over time. Therefore, using the actual theoretical bounds on flow values may result in impractical recommendations that are possible in theory but not in the reality of the system. The novel approaches provided in this disclosure determine actual realistic bounds, such as by examining univariate and multivariate relationships in historical data, in order to produce practical recommendations for optimizing a power generation system.

In addition, some systems are often not well-instrumented, and sites often do not monitor all steam or other material flows closely. As a result, mass balance and optimization become difficult to achieve due to unmetered flows in and out of the system. The novel approaches provided in this disclosure use one or more techniques to deal with unknown values. For example, one technique can involve estimating unknown flows, such as by solving systems of equations or correlating flows with valve positions (such as “percentage open” values). Another technique can involve treating unmetered flows as optimization variables that can fluctuate within the power generation system based on the values of other optimization variables.

The novel approaches described in this disclosure can therefore be used to increase or maximize power generated by turbogenerators 304a-304c or other thermodynamic power generation components 104 at a specified facility or to achieve some other goal(s) associated with the turbogenerators 304a-304c or other thermodynamic power generation components 104. In some cases, generated powers are modeled via one or more machine learning algorithms, and steam flow allocations or other material flow allocations to or from the turbogenerators 304a-304c or other thermodynamic power generation components 104 are optimized subject to various physical and engineering constraints and demands of the specified facility.

With respect to modeling of turbogenerators 304a-304c or other thermodynamic power generation components 104, since a power generation system’s reality often does not adhere to its theoretical physical rules, a data-driven machine learning approach is used for modeling power. In some instances, machine learning models 122, 314 for turbogenerators 304a-304c or other thermodynamic power generation components 104 may depend on steam input and extraction flows or other material flows only and may represent linear machine learning models. Although these simple machine learning models 122, 314 may not necessarily adhere to theoretical formulas precisely, this data-driven approach still produces feasible and useful results. Note, however, that more complex machine learning models 122, 314 may be used, such as those trained based on historical sensor data for steam flows, temperatures, pressures, and/or calculated metrics for enthalpy and entropy.

With respect to optimization of steam flow allocations or other material flow allocations to or from the turbogenerators 304a-304c or other thermodynamic power generation components 104, the flow allocations to or from the turbogenerators 304a-304c or other thermodynamic power generation components 104 can be determined using an objective function. In some cases, the objective function can be expressed in terms of maximizing the sum of the generated power across all turbogenerators 304a-304c or other thermodynamic power generation components 104. In these or other cases, the designated optimization variables can include the material flows to or from the turbogenerators 304a-304c or other thermodynamic power generation components 104, which may represent the independent variables in machine learning regression equations used to model the turbogenerators 304a-304c or other thermodynamic power generation components 104 in some embodiments.

Note that the objective function also typically includes or is controlled by constraints associated with a process facility. There are often a multitude of constraints associated with a power generation system, such as mass balances, downstream demands, historical flow maximums, and more. Some of these constraints may involve system design choices, as well, such as whether to shut down or start up a turbogenerator 304a-304c or other thermodynamic power generation component 104. Once again, the reality of a power generation system typically does not adhere to theoretical mass balance equations. Thus, some embodiments of the novel approaches provided in this disclosure can include one or more bounded slack terms in the objective function to ensure realistic mass balances on all steam headers 302a-302c or other components and on the overall power generation system. To ensure that the optimizer 316 does not use the slack term(s) to inflate inputs to the overall system, the objective function can be amended to penalize the magnitude of the slack term(s). Moreover, since some embodiments of the novel approaches provided in this disclosure can create predictions and allow flexible values for unmetered flows, an optimization model can be created that adequately captures the entire physical system of a facility and satisfies all constraints during optimization.

The novel approaches provided in this disclosure can provide various benefits or advantages depending on the implementation. For example, using a combination of data-driven machine learning and dynamic optimization can support process optimization for many different operational plants and other process facilities. Moreover, these approaches can be flexible in order to uphold different types of constraints, such as mass balance constraints, historical variable ranges, energy requirements, efficiency minimums, and more. Further, the objective function used for optimization can be easily restructured to maximize power, maximize efficiency, reduce energy usage, reduce costs, or achieve some other desired result. In addition, the optimizations obtained using the described approaches can achieve significant environmental benefits and monetary savings.

To summarize, at a high level, the novel approaches described in this patent document leverage the dual approach of using machine learning and physics-based optimization to solve a steam system or other power generation system’s balance. In some cases, the novel approaches can use one or more slack terms to ensure mass balances and can use reasonable historical bounds on variables (instead of inaccurate theoretical limits). Also, in some cases, the novel approaches can handle unmetered flows, such as by predicting these flows or by modeling them as flexible optimization flows.

The following now describes a specific implementation of the novel approaches and how these approaches may be used with a steam-based power generation system or other power generation system. Note that the specific details provided below are for illustration only and can vary as needed or desired. For instance, specific equations are provided below for features such as an objective function, and these equations may be modified as needed or desired. As a particular example, specific equations below often assume that three turbogenerators 304a-304c having the configurations shown in FIG. 3 are used. However, since the number of turbogenerators or other thermodynamic power generation components 104 and the configuration of each turbogenerator or other thermodynamic power generation component 104 may vary, the equations can similarly be modified as needed or desired. Also, any single feature or any combination of features described below may be used in the systems 100, 300 and/or supported by the device 200 described above. In addition, while operations are often described below as being performed by the optimizer 316, the same operations may be performed using the machine learning optimization module 246 and other components in the functional architecture 220.

The machine learning models 122, 314 enable the systems 100, 300 described above to engage in dynamic optimization of the associated turbogenerators 304a-304c or other thermodynamic power generation components 104. In some embodiments, this can be done in real-time based on information obtained from the sensors 106, 310, and the machine learning models 122, 314 may be used to maximize power generated by the turbogenerators 304a-304c or other thermodynamic power generation components 104 or meet some other goal(s). The optimization can be performed subject to all system constraints, such as mass balances, steam or other material usage demands, and historical data bounds. In some cases, some or all “state” variables may be held constant, such as steam or other material flows into the system 102, 300, consumption of steam or other material by a plant or other process facility, and the amount of steam or other material going to blowers, deaerators, or other components in the system 102, 300.

In some embodiments, each turbogenerator 304a-304c or other thermodynamic power generation component 104 may have its own machine learning model 122, 314, and that machine learning model 122, 314 can be used to predict the power generated by that machine learning model 122, 314. A wide variety of machine learning model structures may be used to represent each turbogenerator 304a-304c or other thermodynamic power generation component 104. For example, regression may be used to generate each of the machine learning models 122, 314 based on treating the input and extraction flows of the associated turbogenerator 304a-304c or other thermodynamic power generation component 104 as independent variables. Regression analysis based on steam or other material flows can be useful here due to its strong performance, its ease of use, and its convexity (which supports optimization). Note that there may be little or no concern about overfitting each machine learning model 122, 314 due to the desire for the machine learning model 122, 314 to perform as well as possible based on historical data.

Various types of regression analyses may be used to produce the machine learning models 122, 314. Specific example types of regression analyses that might be used could include a linear or dummy regression analysis based on the input and extraction flows, a linear regression analysis with quadratic terms based on the input and extraction flows, a linear or dummy regression analysis based on the input and extraction flows and measured/estimated enthalpies, or a linear regression analysis with quadratic terms based on the input and extraction flows and the measured/estimated enthalpies. Depending on the circumstances, different types of machine learning models 122, 314 may be used to represent different turbogenerators 304a-304c or other thermodynamic power generation components 104, or the same type of machine learning model 122, 314 may be used to represent the turbogenerators 304a-304c or other thermodynamic power generation components 104. One overall goal here may be to design one or more machine learning models 122, 314 that can accurately predict the amounts of power generated by the turbogenerators 304a-304c or other thermodynamic power generation components 104, such as based on sensor measurements (like sensor measurements associated with input and extraction flows).

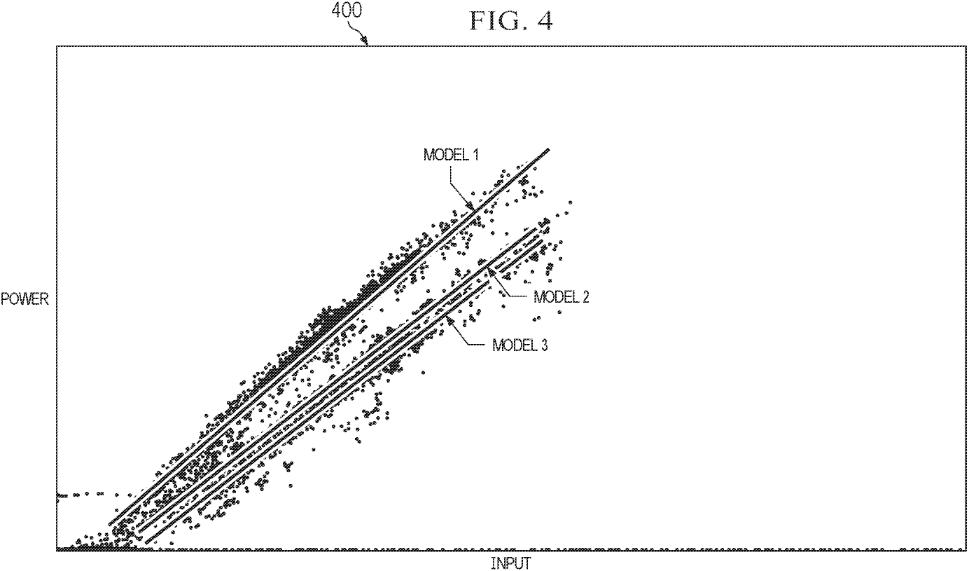

FIG. 4 illustrates an example graph 400 identifying regressions used to create machine learning models to support machine learning-based optimization of thermodynamic power generation according to this disclosure. As shown in FIG. 4, the graph 400 plots power generated by a turbogenerator 304a-304c or other thermodynamic power generation component 104 against input to the turbogenerator 304a-304c or other thermodynamic power generation component 104 (such as an input flow of steam or other material). As can be seen here, regression can be used to generate one or more models that associate the generated power with the steam or other material input flow. In this particular example, three models are shown. This may be indicative of the fact that operation of the turbogenerator 304a-304c or other thermodynamic power generation component 104 can be modeled using different models, and a specific model can be selected for use at any given time (such as based on which model appears to be currently the most accurate). In other instances, a different number of models (including a single model) may be generated for a turbogenerator 304a-304c or other thermodynamic power generation component 104. Note that while the models here are said to represent the behavior of a single turbogenerator 304a-304c or other thermodynamic power generation component 104, it may be possible for a model to represent the combined behavior of multiple turbogenerators 304a-304c or other thermodynamic power generation components 104.

In some cases, the equations used to model the turbogenerators 304a-304c or other thermodynamic power generation components 104 can be used in an optimization objective function or to generate information that is used in the optimization objective function, such as an objective function that is solved using the optimizer 316 in order to predict how the turbogenerators 304a-304c or other thermodynamic power generation components 104 should be controlled to maximize power generation or meet some other goal(s). In these cases, linear regression can be useful when generating the models of the turbogenerators 304a-304c or other thermodynamic power generation components 104 since the coefficients of the linear models can be directly input into the objective function.

In some embodiments, the objective function used with the system 102, 300 may be defined as follows.

$$max \text{inize} {f}_{1} \left({i}_{1} , {e}_{1}\right) + {f}_{2} \left({i}_{2} , {e}_{2}\right) + {f}_{3} \left({i}_{3} , {e}_{3}\right) + \qquad \text{(1)}$$

Here, ƒⱼ(·) represents a prediction of the power generated by the j^{th} turbogenerator 304a-304c or other thermodynamic power generation component 104, iⱼ represents the inlet flow(s) of steam or other material to the j^{th} turbogenerator 304a-304c or other thermodynamic power generation component 104, and eⱼ represents the extraction flow(s) of steam or other material from the j^{th} turbogenerator 304a-304c or other thermodynamic power generation component 104 (where j = 1, 2, 3, ...). In these embodiments, the variables iⱼ and eⱼ can represent optimization variables that may be modified by the optimizer 316 to solve the optimization problem and generate a solution to the optimization problem, which represents control optimization guidance.

The solution to the optimization problem defined by the objective function here is subject to various constraints associated with the system 102, 300. Example constraints can include mass balance constraints, production demands, historical data bounds, and power limits. Mass balance constraints are generally associated with the conservation of mass and require an accounting of all material entering and leaving a system 102, 300. Production demands are generally associated with limitations placed on the amount of steam or other material available for use in generating power or performing other functions. Historical data bounds are generally associated with realistic (rather than theoretical) limitations placed on operations or components in the system 102, 300. Power limits are generally associated with limitations on the amount of power that can be used or generated by components in the system 102, 300.

In some cases, the optimizer 316 may use a mathematical solver to optimize the input and extraction flows defined in Equation (1) above while both (i) satisfying all system constraints and (ii) maximizing the total power produced by the turbogenerators 304a-304c or other thermodynamic power generation components 104. By satisfying all system constraints, the optimizer 316 can ensure that constraints on mass balances, steam or other material usage demands, historical data bounds, etc. are upheld, which means that the resulting solution to the optimization problem is actually feasible (so it is possible to actually adjust the steam or other material flows in accordance with the resulting solution). Note that the optimizer 316 may hold other state variables in the system 102, 300 constant during the optimization. This may allow, for instance, the optimizer 316 to hold variables such as other outputs, input flows to blower turbines or other components, and consumptions of steam or other material by other components constant.

As noted above, one or multiple machine learning models may be used to represent the behavior of a turbogenerator 304a-304c or other thermodynamic power generation component 104. For example, in some instances, turbogenerators 304a-304c or other thermodynamic power generation components 104 may not show significant degradation or other changes in operation over time, so a single prediction model may be sufficient for each of those turbogenerators 304a-304c or other thermodynamic power generation components 104.

In other instances, turbogenerators 304a-304c or other thermodynamic power generation components 104 may show significant degradation or other changes in operation over time, and each of those turbogenerators 304a-304c or other thermodynamic power generation components 104 may appear to operate in different operational modes over time. This can be due to various factors, such as backpressure leakage or degradation of the turbogenerator 304a-304c or other thermodynamic power generation component 104 itself or related components (such as a pipe leading to or from or a valve associated with the turbogenerator 304a-304c or other thermodynamic power generation component 104). In those cases, multiple machine learning models may be defined based on the historical period’s timestamps for these turbogenerators 304a-304c or other thermodynamic power generation components 104. In these cases, the machine learning substitution module 250 may operate as described above the select the appropriate machine learning models 122, 314 at different times.

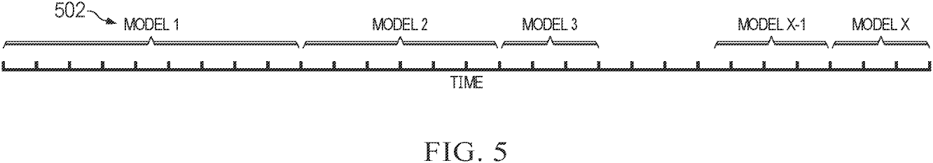

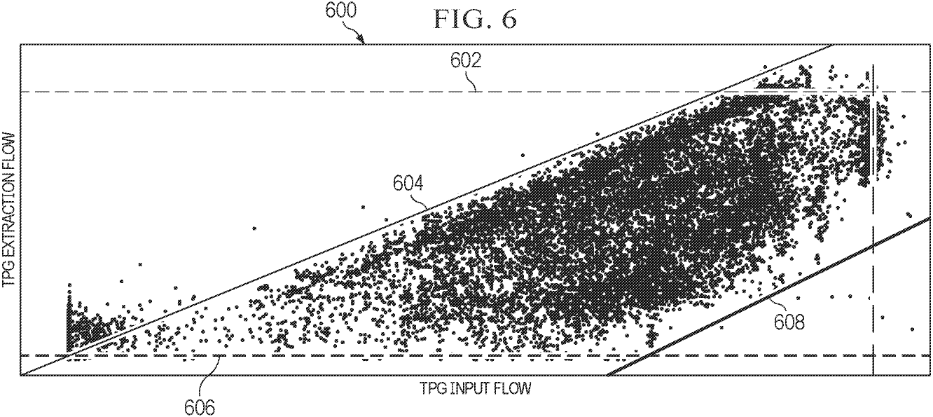

FIG. 5 illustrates an example usage of multiple machine learning models to support machine learning-based optimization of thermodynamic power generation according to this disclosure. As can be seen in FIG. 5, for instance, multiple machine learning models 502 can be defined for the same turbogenerator 304a-304c or other thermodynamic power generation component 104 over time. This allows a more appropriate machine learning model to be used to predict power generation by that turbogenerator 304a-304c or other thermodynamic power generation component 104, even as the characteristics of the power generation change over time. Note that each machine learning model 502 can have any suitable structure, and the machine learning models 502 may or may not have the same structure. Also note that each machine learning model 502 may be trained using any suitable training data, such as data associated with the corresponding operational mode of the turbogenerator 304a-304c or other thermodynamic power generation component 104.

As noted above, realistic constraints of the system 102, 300 can be identified based on historical data associated with the system 102, 300. Often times, theoretical limits on the turbogenerators 304a-304c or other thermodynamic power generation components 104 or other components of the system 102, 300 can differ (possibly significantly) from what can actually be achieved in the real world. Historical data associated with the system 102, 300 can be used to identify realistic constraints of the system 102, 300, and the optimizer 316 can enforce those realistic constraints when solving the optimization problem described above. This allows the control optimization guidance produced by the optimizer 316 to be feasible in view of realistic constraints and not just theoretical constraints.

In some cases, the realistic constraints of the system 102, 300 can be identified for the input and extraction steam flows or other material flows into or out of the turbogenerators 304a-304c or other thermodynamic power generation components 104. As a particular example, historical data (such as the 99^{th} percentile of the historical data) can be obtained and used (such as by the application server 114 or control system 108, 312) to identify linear or other upper bounds or other bounds on the input and extraction steam flows or other material flows into or out of the turbogenerators 304a-304c or other thermodynamic power generation components 104. FIG. 6 illustrates an example definition 600 of historical bounds used to support machine learning-based optimization of thermodynamic power generation according to this disclosure. As shown in FIG. 6, a number of data points identify extraction flows of steam or other material in relation to input flows of steam or other material for a turbogenerator 304a-304c or other thermodynamic power generation component 104.

In FIG. 6, lines 602, 604, 606, and 608 or other markings are shown here to visually identify polygonal constraints or other constraints that may be captured and used to define the actual physical (real world) relationship between the input and extraction flows for this particular turbogenerator 304a-304c or other thermodynamic power generation component 104. Different constraints (such as different polygons) may be defined for each turbogenerator 304a-304c or other thermodynamic power generation component 104 based on the actual operation of that turbogenerator 304a-304c or other thermodynamic power generation component 104. The optimizer 316 may use these constraints when determining how to optimize the flows of steam or other material to or from the turbogenerators 304a-304c or other thermodynamic power generation components 104 in order to increase or maximize power generation or achieve some other goal(s).

Note that the objective function shown in Equation (1) above can be easily modified based on the specific power generation system being controlled. For example, the objective function shown in Equation (1) above may be customized for the specific power generation system 300 shown in FIG. 3 as follows.

$$\text{maximize} {f}_{1} \left({i}_{1} , {e}_{1}\right) + {f}_{2} \left({i}_{2} , {e}_{2 , m p} , {e}_{2 , 1 p}\right) + {f}_{3} \left({i}_{3}\right) \qquad \text{(2)}$$

In this example, ƒⱼ(·) is associated with a first turbogenerator 304a or other thermodynamic power generation component 104, ƒ₂(·) is associated with the turbogenerator 304b or other thermodynamic power generation component 104, and ƒ₃(·) is associated with the turbogenerator 304c or other thermodynamic power generation component 104. Consistent with FIG. 3, it is assumed here that the first turbogenerator 304a or other thermodynamic power generation component 104 has a single input flow and a single extraction flow that can be controlled. It is also assumed here that the second turbogenerator 304b or other thermodynamic power generation component 104 has a single input flow and two extraction flows (a medium-pressure (mp) flow and a low-pressure (lp) flow) that can be controlled. It is further assumed here that the third turbogenerator 304c or other thermodynamic power generation component 104 has a single input flow that can be controlled. Other arrangements of turbogenerators or other thermodynamic power generation components and configurations of those turbogenerators or other thermodynamic power generation components can be accommodated via appropriate definitions in the objective function.

In many cases, the mass balance constraints described above can be of a form in which total input flow equals total output flow. In other words, the amount of steam or other material flowing into or otherwise entering a turbogenerator 304a-304c or other thermodynamic power generation component 104 equals the amount of steam or other material flowing out of or otherwise exiting the turbogenerator 304a-304c or other thermodynamic power generation component 104. However, in some cases, precision measurements may be difficult or impossible to obtain across all timestamps, such as due to one or more faulty sensors 106, 310 or valves 306. To help compensate for this, one or more slack variables can be added to the objection function in order to allow a small level of mismatch between the input and output masses (or other constraints) and to increase the flexibility of the optimizer 316. Depending on the implementation, slack variables can be positive or negative, and the objection function can include a penalty based on the slack variables’ values. This penalty may be useful, for example, to help prevent the optimizer 316 from using the slack variables(s) to inflate inputs to the overall system 102, 300 being controlled. As a particular example, the objective function of Equation (2) may be expanded to include the slack variables as follows.

$$\text{maximize} {f}_{1} \left({i}_{1 ,} {e}_{1}\right) + {f}_{2} \left({i}_{2} , {e}_{2 , m p} , {e}_{2 , l p}\right) + {f}_{3} \left({i}_{3}\right) - \text{λ} {\left‖S\right‖}_{2}^{2} \qquad \text{(3)}$$

Here, λ represents a regularization penalty for the slack variables, and S = [s₁ s₂ ... sₓ]^{T} represents x slack variables for mass balance equations or other constraints. A similar approach may be used to add one or more slack variables and at least one penalty to the more-generic objective function of Equation (1).

In some cases, all of the desired information to be used by the machine learning models 122, 314 is available for use, such as when sensors 106, 310 are available and operational and can provide the desired information. In other cases, some of the desired information to be used by the machine learning models 122, 314 is not available for use, such as when one or more characteristics of the system 102, 300 are unmetered. In those cases, it is still possible for control optimization guidance to be generated, even in the presence of one or more unmetered characteristics associated with system 102, 300. For example, each unmetered characteristic may be determined based on actual collected information (such as from one or more sensors 106, 310 that are available) or treated as an optimization variable (such as one that fluctuates based on at least one other optimization variable). As a particular example of this, an input flow to a particular turbogenerator 304a-304c or other thermodynamic power generation component 104 may be unmetered, but each extraction flow from the particular turbogenerator 304a-304c or other thermodynamic power generation component 104 may be metered. In this case, it is possible to derive the input flow to the particular turbogenerator 304a-304c or other thermodynamic power generation component 104 based on mass balance and the extraction flow(s). As another particular example of this, the pressure of an input flow to a particular turbogenerator 304a-304c or other thermodynamic power generation component 104 may be unmetered, but the temperature and flow rate of the input flow to the particular turbogenerator 304a-304c or other thermodynamic power generation component 104 may be metered. In that case, it may be possible to treat the pressure of the input flow to the particular turbogenerator 304a-304c or other thermodynamic power generation component 104 as a variable that fluctuates based on the known temperature and flow rate of the input flow to the particular turbogenerator 304a-304c or other thermodynamic power generation component 104.

Note that the specific mass balance, production demand, and other equations that are used will depend on the specific system 102, 300 being modeled and controlled. For example, the specific mass balance, production demand, and other equations that are used will often depend on the specific number of turbogenerators 304a-304c or other thermodynamic power generation components 104 and how steam or other material specifically flows to and from the turbogenerators 304a-304c or other thermodynamic power generation components 104. The specific mass balance, production demand, and other equations that are used will also often depend on how the steam or other material that flows to and from the turbogenerators 304a-304c or other thermodynamic power generation components 104 is specifically used by other components (such as manufacturing or processing components that use the steam or other material in a process facility).

Also note that the constraints used by the optimizer 316 during the generation of control optimization guidance, or even the terms in the objective function itself, can vary depending on the circumstances in the system 102, 300. For example, turbogenerators 304a-304c or other thermodynamic power generation components 104 may be turned off at various points during operation of a system 102, 300. This may be due to any number of factors, such as maintenance or mechanical issues involving the turbogenerators 304a-304c or other thermodynamic power generation components 104 or involving other components of the system 102, 300. When a specific turbogenerator 304a-304c or other thermodynamic power generation component 104 is turned off, the optimizer 316 can force the input and extraction flows for that turbogenerator 304a-304c or other thermodynamic power generation component 104 to be zero, and the optimizer 316 may temporarily remove any constraints that are violated by such a zero flow rate. This may allow the optimizer 316 to continue optimization operations for the remaining turbogenerators 304a-304c or other thermodynamic power generation components 104, thereby allowing continuing optimization of the power generation or other operations in the system 102, 300 by the remaining turbogenerators 304a-304c or other thermodynamic power generation components 104.

Although FIGS. 4 through 6 illustrate examples of operations or features that may be used to support machine learning-based optimization of thermodynamic power generation, various changes may be made to FIGS. 4 through 6. For example, the data points and models shown in FIG. 4, the number of models and time intervals shown in FIG. 5, and the historical bounds shown in FIG. 6 are for illustration only and can vary widely depending on the specific system 102, 300 being controlled.

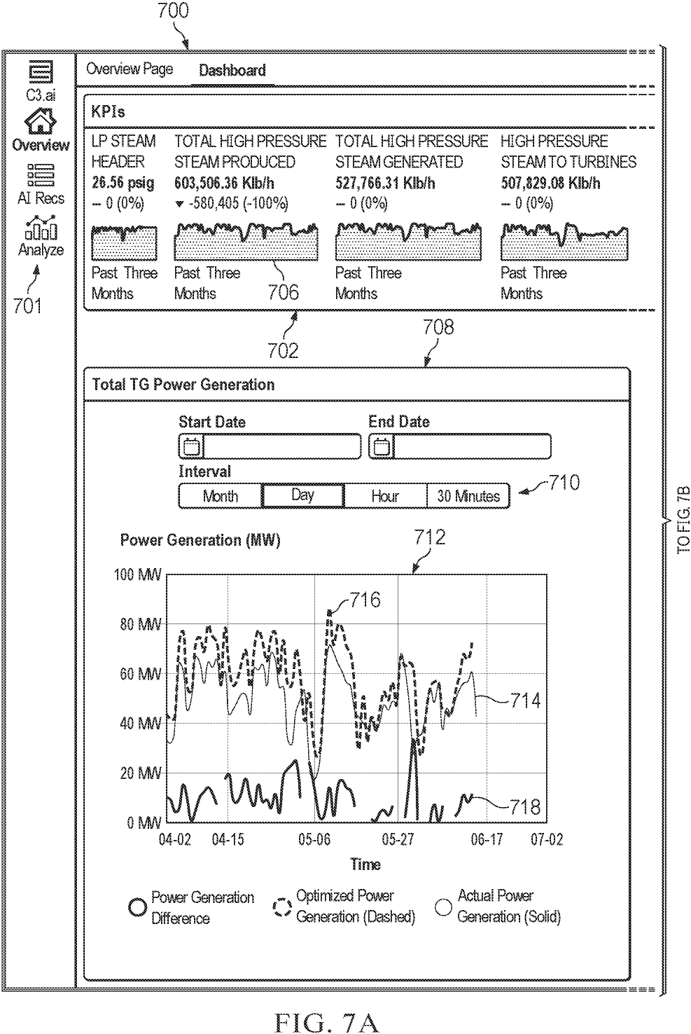

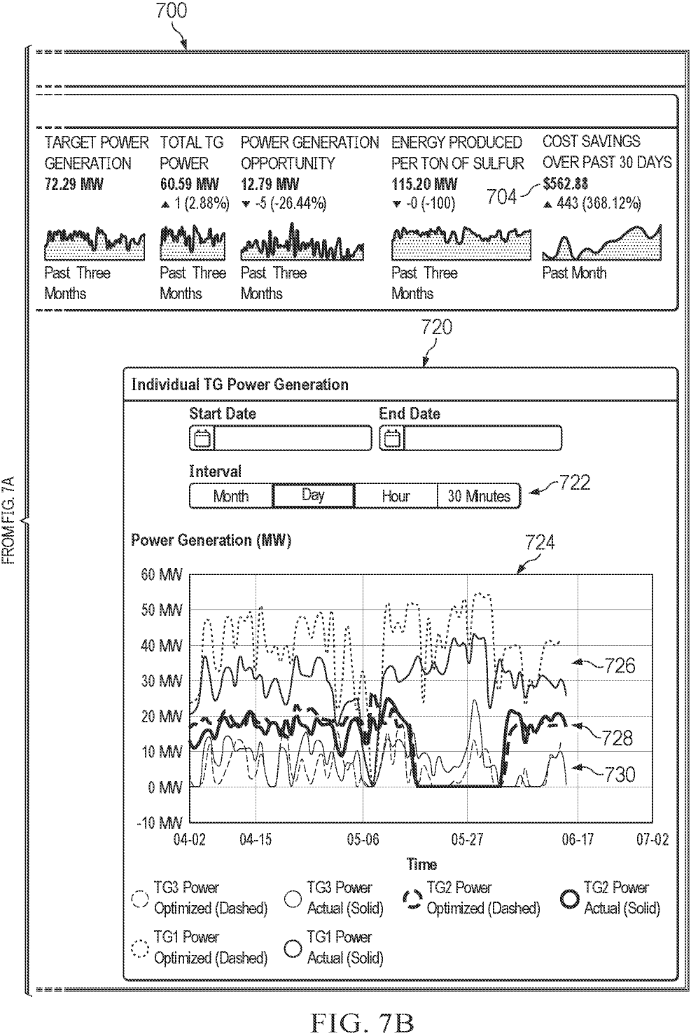

FIGS. 7A through 9 illustrate an example graphic user interface 700 that can be used to support machine learning-based optimization of thermodynamic power generation according to this disclosure. For example, the graphical user interface 700 may be generated by the application server 114 or by the control system 108, 312 (if the functionality of the application server 114 is incorporated into the control system 108, 312) and presented on one or more of the user devices 102a-102d. As shown in FIGS. 7A and 7B, the graphic user interface 700 includes various controls 701, which allow a user to view different information related to thermodynamic power generation.

In this example, the user has opted to view overview information related to thermodynamic power generation. Based on this selection, the graphic user interface 700 presents information related to various key performance indicators (KPIs) 702, which include values associated with various aspects of the system 102, 300 being controlled. In this particular example, the key performance indicators 702 include values related to pressure and amounts of steam produced and used. The key performance indicators 702 also include values related to a total amount of power generated, a targeted amount of power generation, and an opportunity for improved power generation. The key performance indicators 702 further include values related to energy produced and cost savings obtained. These values may be generated by the control system 108, 312, the application server 114, or other component(s) based on historical and current data associated with operation of the system 102, 300. In some cases, at least one value of at least one key performance indicator 702 may include change information 704 identifying how the value of the key performance indicator 702 has changed over a recent or other time period. Also, in some cases, at least one value of at least one key performance indicator 702 may be associated with a graph 706 that graphically identifies how the value of the key performance indicator 702 has changed over a recent or other time period.

The graphical user interface 700 also includes a total power generation section 708, which presents information regarding total power generation by the turbogenerators 304a-304c or other thermodynamic power generation components 104. In this example, the total power generation section 708 includes controls 710 that allow the user to define the time period and the time interval for which total power generation information is presented. The total power generation section 708 also includes a graph 712 plotting the selected total power generation information. In this particular example, the graph 712 includes a line 714 plotting actual total power generation by the turbogenerators 304a-304c or other thermodynamic power generation components 104. The graph 712 also includes a line 716 plotting what the optimized prediction of the total power generation was for the turbogenerators 304a-304c or other thermodynamic power generation components 104. The graph 712 further includes a line 718 plotting the differences between the two lines 714, 716.

The graphical user interface 700 further includes an individual power generation section 720, which presents information regarding power generation by individual ones of the turbogenerators 304a-304c or other thermodynamic power generation components 104. In this example, the individual power generation section 720 includes controls 722 that allow the user to define the time period and the time interval for which individual power generation information is presented. The individual power generation section 720 also includes a graph 724 plotting the selected individual power generation information. In this particular example, the graph 724 includes a pair of lines 726, 728, 730 for each turbogenerator 304a-304c or other thermodynamic power generation component 104. Each pair of lines 726, 728, 730 plots the actual power generation and optimized predicted power generation for each turbogenerator 304a-304c or other thermodynamic power generation component 104.

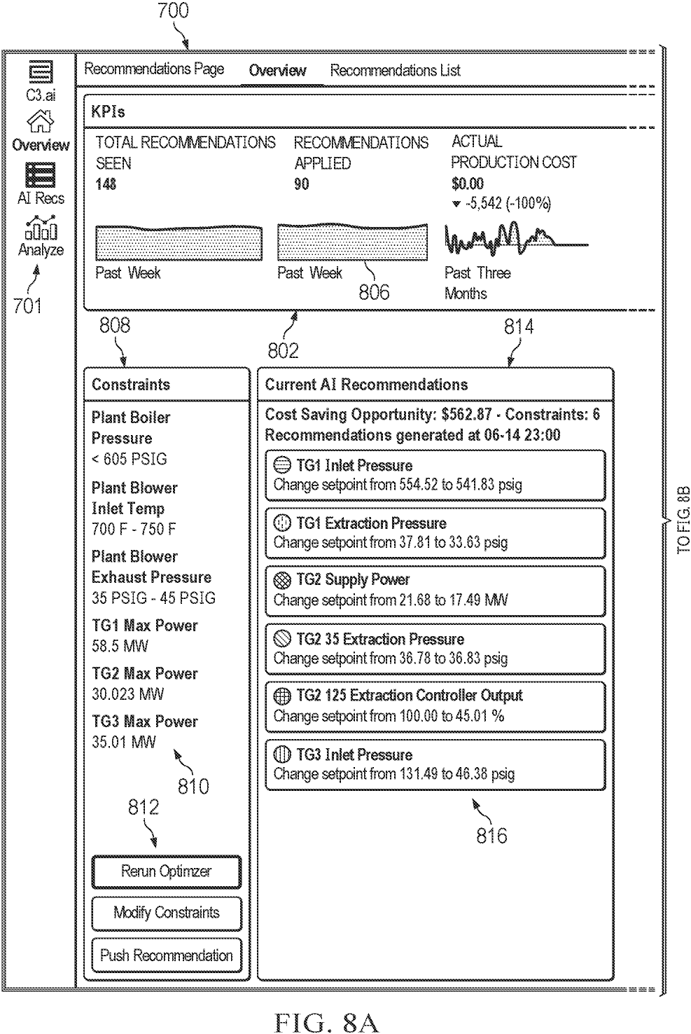

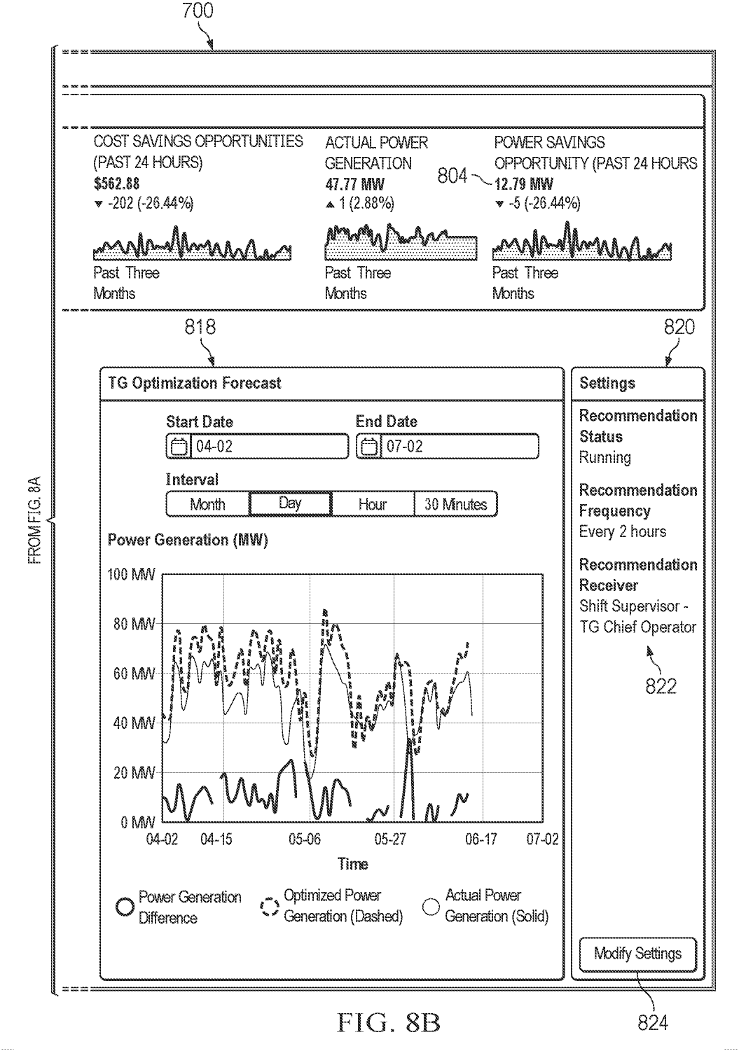

If the user selects the AI recommendations (“AI Recs”) control 701, the graphical user interface 700 may include information shown in FIGS. 8A and 8B. As shown in FIGS. 8A and 8B, the graphic user interface 700 here presents information related to various key performance indicators 802 for recommendations made using the machine learning models 122, 314 and the optimizer 316. In this example, the key performance indicators 802 include a number of recommendations made and a number of recommendations implemented within a given time period. The key performance indicators 802 also include actual production costs and cost savings opportunities in a recent or other time period. The key performance indicators 802 further include actual power generation and an opportunity for improved power generation. These values may be generated by the control system 108, 312, the application server 114, or other component(s) based on historical and current data associated with operation of the system 102, 300. In some cases, at least one value of at least one key performance indicator 802 may include change information 804 identifying how the value of the key performance indicator 802 has changed over a recent or other time period. Also, in some cases, at least one value of at least one key performance indicator 802 may be associated with a graph 806 that graphically identifies how the value of the key performance indicator 802 has changed over a recent or other time period.

The graphical user interface 800 also includes a constraints section 808, which identifies various constraints 810 and their associated values. The various constraints 810 may be determined in any suitable manner, such as based on historical data as described above. The constraints section 808 also includes controls 812 that allow the user to invoke execution of the optimizer 316, modify the constraints 810, and push AI-based recommendations out for actual use or implementation. The graphical user interface 800 further includes a recommendation section 814, which includes one or more AI-based recommendations 816. Each AI-based recommendation 816 can represent a setting or other recommendation that the optimizer 316 identifies as potentially increasing the amount of power generation or as potentially achieving some other goal or goals (as defined by the objective function being used by the optimizer 316). In some cases, each AI-based recommendation 816 may be selectable by the user, and any selected AI-based recommendations 816 can be pushed out for actual use or implementation via the appropriate control 812. Note, however, that other implementations are also possible, such as when AI-based recommendations 816 are automatically implemented without user approval.

The graphical user interface 800 also includes a total power generation section 818, which can be similar in content and form as the total power generation section 708. In addition, the graphical user interface 800 includes a settings section 820, which allows the user to control various settings 822 related to the generation of AI-based recommendations. For example, the settings 822 may be used to control whether or not the AI-based recommendations are being generated, at what frequency the Al-based recommendations are being generated, and one or more personnel who receive the AI-based recommendations. A control 824 may be selected by the user to modify one or more of these settings 822 or other settings.

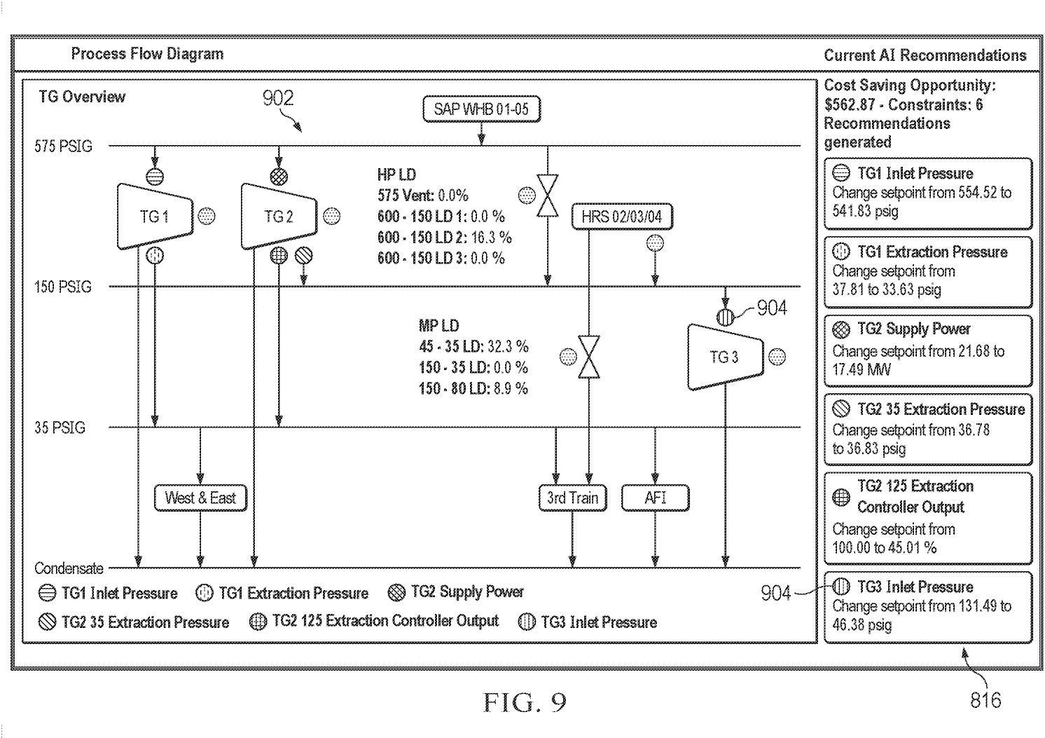

Note that the AI-based recommendations 816 generated here may be presented in any other suitable manner. For instance, as shown in FIG. 9, the AI-based recommendations 816 may be displayed along with a graphical representation 902 of at least a portion of the system 102, 300 being controlled. The graphical representation 902 can include various information about the system 102, 300 being controlled, such as symbols representing turbogenerators 304a-304c or other thermodynamic power generation components 104 and related equipment and flow paths to and from the turbogenerators 304a-304c or other thermodynamic power generation components 104 or other connections in the system 102, 300. The graphical representation 902 can also include settings of the turbogenerators 304a-304c or other thermodynamic power generation components 104 or settings of the related equipment, such as for valves or other components associated with the turbogenerators 304a-304c or other thermodynamic power generation components 104. In this example, each AI-based recommendation 816 may be associated with a color-coded or other indicator 904, and each indicator 904 may also appear within the graphical representation 902. This may allow the user to quickly identify where each AI-based recommendation 816 would be applied within the overall system 102, 300 being controlled.

Although FIGS. 7A through 9 illustrate one example of a graphic user interface 700 that can be used to support machine learning-based optimization of thermodynamic power generation, various changes may be made to FIGS. 7A through 9. For example, the content, layout, and arrangement of the graphical user interface can easily vary from those shown here. Graphical user interfaces can come in a wide variety of designs and configurations, and FIGS. 7A through 9 do not limit the scope of this disclosure to any particular graphical user interfaces.

It should be noted that the functions described above can be implemented in any suitable manner. For example, in some embodiments, at least some of the functions described above can be implemented or supported using one or more software applications or other software instructions that are executed by one or more processing devices 202. In other embodiments, at least some of the functions described above can be implemented or supported using dedicated hardware components. In general, the functions described above can be performed using any suitable hardware or any suitable combination of hardware and software/firmware instructions. Also, the functions described above can be performed using a single device or any suitable combination of devices.

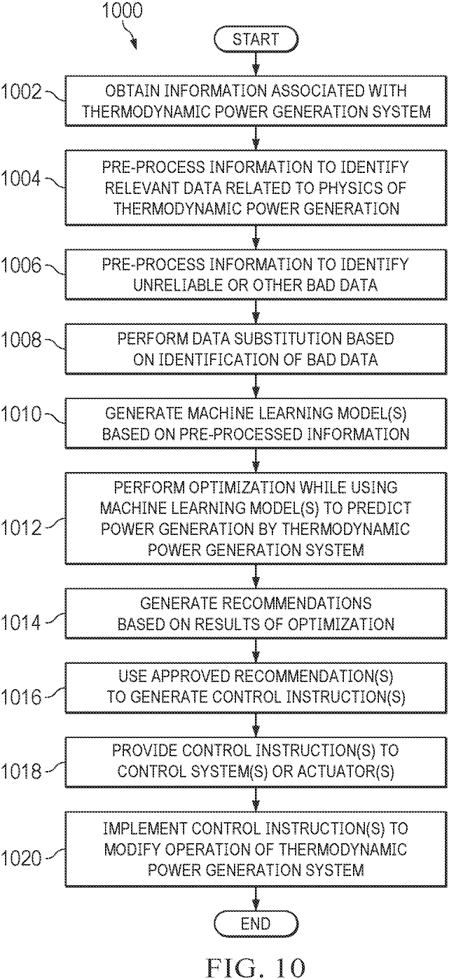

FIG. 10 illustrates an example method 1000 for machine learning-based optimization of thermodynamic power generation according to this disclosure. The method 1000 may, for example, be performed using one or more components of the system 100 and the functional architecture 220 described above in order to control operations within the thermodynamic power generation system 102. However, the method 1000 may be performed using any suitable device(s) and in any suitable system(s), and the method 1000 may be used to control any other suitable thermodynamic power generation system(s) (such as the thermodynamic power generation system 300) or other processes.

As shown in FIG. 10, information associated with a thermodynamic power generation system is obtained at step 1002. This may include, for example, the processing device 202 of the control system 108 or the application server 114 obtaining sensor measurements from the sensors 106 or information based on the sensor measurements from the sensors 106. This may also include the processing device 202 of the control system 108 or the application server 114 obtaining any other or additional information regarding the thermodynamic power generation system 102, such as information associated with control signals generated by the control system 108 over time, calculated metrics associated with the thermodynamic power generation system 102, or other information. The information may generally relate to any suitable characteristics in the thermodynamic power generation system 102, and the information may be obtained in any suitable manner.

Pre-processing of the information is performed in order to identify relevant data that relates to the physics of the thermodynamic power generation at step 1004. This may include, for example, the processing device 202 of the control system 108 or the application server 114 performing or using the physics translation module 234 to identify information related to power generation and any factors that appear to have an influence on the amount of power generated. Pre-processing of the information is also performed in order to identify unreliable or other bad or invalid data in the obtained information at step 1006. This may include, for example, the processing device 202 of the control system 108 or the application server 114 performing or using the data time-series congruence module 236 to identify data that might be inconsistent and performing or using the anomalous data detection module 238 to identify bad data. Data substitution is performed based on the identification of bad data at step 1008. This may include, for example, the processing device 202 of the control system 108 or the application server 114 performing or using the data substitution module 240 to identify one or more replacement data values, proxy variables, or otherwise substituting good or replacement data for the identified bad or invalid data.

One or more machine learning models are generated using the pre-processed data at step 1010. This may include, for example, the processing device 202 of the control system 108 or the application server 114 performing or using the machine learning translation module 244 to generate one or more machine learning models 122 associated with one or more thermodynamic power generation components 104 of the thermodynamic power generation system 102. The machine learning translation module 244 may perform any suitable analysis or analyses to generate the machine learning model(s) 122, such as one or more linear regressions or other regressions.

Optimization is performed while using the one or more machine learning models to predict power generation by the thermodynamic power generation system at step 1012. This may include, for example, the processing device 202 of the control system 108 or the application server 114 performing or using the machine learning optimization module 246 to maximize or minimize an objective function associated with at least one desired goal (such as maximum power generation or other goals discussed above). This may also include the processing device 202 of the control system 108 or the application server 114 performing or using the machine learning optimization module 246 to incorporate the consideration of one or more slack variables, such as to account for a small level of mismatch between certain constraints associated with the thermodynamic power generation system 102. This may further include the processing device 202 of the control system 108 or the application server 114 using the cost function module 248 to penalize the use of the one or more slack variables. The optimization here can consider the constraints on the thermodynamic power generation system 102 when maximizing or minimizing the objective function.

One or more recommendations are generated based on the results of the optimization at step 1014. This may include, for example, the processing device 202 of the control system 108 or the application server 114 performing or using the recommendation generation module 252 to translate the outputs of the optimization (such as an optimization solution representing control optimization guidance) performed by the machine learning optimization module 246 into potential flow rates of materials within the thermodynamic power generation system 102 or into other potential configurations of the thermodynamic power generation system 102. This may also include the processing device 202 of the control system 108 or the application server 114 performing or using the recommendation output translation module 254 to convert each potential configuration into one or more potential actions. The one or more potential actions may optionally be presented to at least one user (such as via the graphical user interface 700) for approval or rejection.

One or more approved recommendations are used to generate one or more control instructions at step 1016. This may include, for example, the processing device 202 of the control system 108 or the application server 114 using the control instruction generator 290 to convert any approved potential configuration of the thermodynamic power generation system 102 into one or more actions, such as one or more setpoints. The one or more actions define how the thermodynamic power generation system 102 can be adjusted in order to achieve an approved configuration. The one or more control instructions are provided to one or more control systems or actuators at step 1018, and the one or more control instructions are implemented to modify the operation of the thermodynamic power generation system at step 1020. This may include, for example, the processing device 202 of the control system 108 or the application server 114 providing the control instruction(s) to one or more actuators or other components, which can cause the one or more actuators or other components to physically adjust one or more characteristics within the thermodynamic power generation system 102.

Although FIG. 10 illustrates one example of a method 1000 for machine learning-based optimization of thermodynamic power generation, various changes may be made to FIG. 10. For example, while shown as a series of steps, various steps in FIG. 10 may overlap, occur in parallel, occur in a different order, or occur any number of times. As a particular example, one or more machine learning models 122 may be generated and then used during multiple iterations through the method 1000 until, for instance, the machine learning substitution module 250 determines that the one or more machine learning models 122 need to be retrained or replaced.

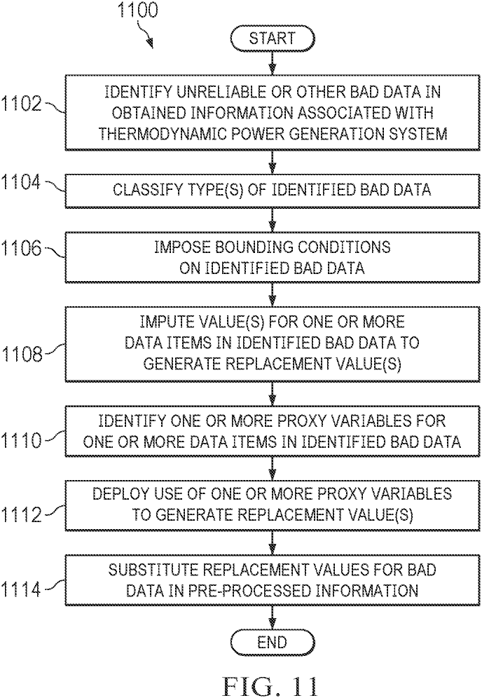

FIG. 11 illustrates an example method 1100 for pre-processing data during machine learning-based optimization of thermodynamic power generation according to this disclosure. The method 1100 may, for example, be performed using one or more components of the system 100 and the functional architecture 220 described above in order to control operations within the thermodynamic power generation system 102. As a particular example, the method 1100 may be performed during or as part of steps 1006-1008 in the method 1000 of FIG. 10. However, the method 1100 may be performed using any suitable device(s) and in any suitable system(s), and the method 1100 may be used to control any other suitable thermodynamic power generation system(s) (such as the thermodynamic power generation system 300) or other processes.

As shown in FIG. 11, unreliable or other bad data in obtained information associated with a thermodynamic power generation system is identified at step 1102, and the type or types of identified bad data are classified at step 1104. This may include, for example, the processing device 202 of the control system 108 or the application server 114 performing or using the data time-series congruence module 236 to identify data that might be inconsistent and performing or using the anomalous data detection module 238 to identify bad or invalid data. This may also include the processing device 202 of the control system 108 or the application server 114 performing or using the data substitution module 240 to classify the bad data. Any suitable classifications of bad data may be identified and used here. For instance, in some cases, the bad data may be classified based on its source, such as whether the bad data represents measurements from one or more sensors 106 or control signals from the control system 108. In other cases, the bad data may be classified based on its data types, such as when each of one or more variables has categorical, continuous, or discrete data values. A combination of these classification approaches may also be used. As particular examples, the processing device 202 of the control system 108 or the application server 114 may use machine learning rules, one or more statistical analyses, one or more engineering analyses, or a combination thereof to identify and classify unreliable or other bad data.

Bounding conditions are imposed on the identified bad data at step 1106. This may include, for example, the processing device 202 of the control system 108 or the application server 114 performing or using the data substitution module 240 to identify upper and lower bounds or other boundaries for each variable associated with the bad data. As noted above, in some cases, this may be based on historical data for each variable associated with the bad data. As particular examples, the processing device 202 of the control system 108 or the application server 114 may use machine learning rules, boundaries based on one or more statistical analyses, one or more engineering boundaries, or a combination thereof to define the boundaries for the variables associated with the bad data.

One or more values for one or more data items in the identified bad data may be imputed to generate one or more replacement values at step 1108. This may include, for example, the processing device 202 of the control system 108 or the application server 114 performing or using the data substitution module 240 to cause an average data value of a variable or a most-frequent data value of a variable to be used as a replacement value for that variable. In some cases, the average or most-frequent data value may be calculated by the statistical system analysis module 242 and provided to the data substitution module 240, or the data substitution module 240 may calculate the average or most-frequent data value. The average or most-frequent data value determined for a variable having bad data can fall within the defined boundaries for that variable. The specific ways in which data values can be imputed may vary depending on the classification, such as when categorical, continuous, and discrete variables are imputed differently using average, most-frequent, or other values.

Also or alternatively, one or more proxy variables can be identified for one or more data items in the identified bad data at step 1110, and the one or more proxy variables can be deployed to generate one or more replacement values at step 1112. This may include, for example, the processing device 202 of the control system 108 or the application server 114 performing or using the data substitution module 240 to identify a proxy variable that is associated with a variable having bad data. This may also include the processing device 202 of the control system 108 or the application server 114 performing or using the data substitution module 240 to calculate one or more replacement values for the variable having bad data, where the one or more replacement values represent one or more values of the proxy variable. Again, each value of the proxy variable can fall within the defined boundaries for the associated variable having bad data.

The replacement values are substituted into the pre-processed information in place of the bad data at step 1114. This may include, for example, the processing device 202 of the control system 108 or the application server 114 performing or using the data substitution module 240 to provide the replacement values to other components of the functional architecture 220 for further processing.

Although FIG. 11 illustrates one example of a method 1100 for pre-processing data during machine learning-based optimization of thermodynamic power generation, various changes may be made to FIG. 11. For example, while shown as a series of steps, various steps in FIG. 11 may overlap, occur in parallel, occur in a different order, or occur any number of times. As a particular example, one or more replacement values may be generated using imputation, using at least one proxy variable, or both depending on the bad data that has been identified.

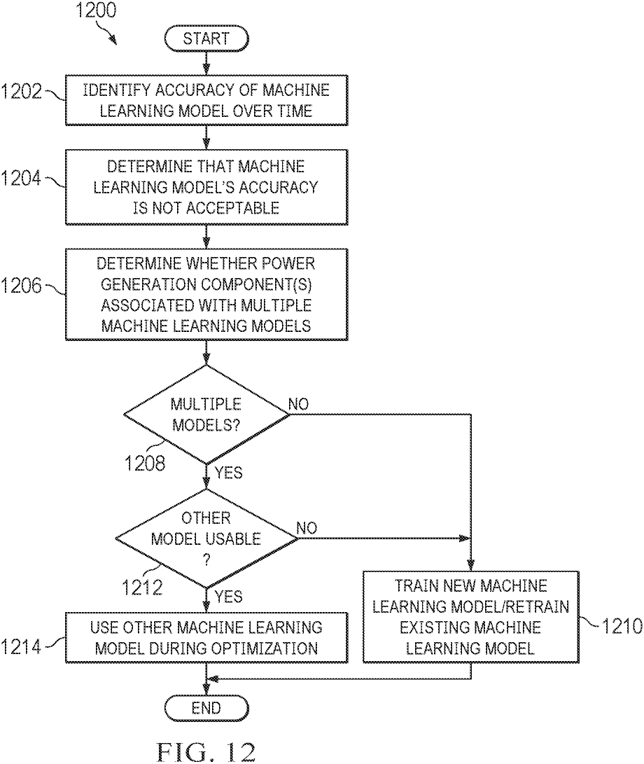

FIG. 12 illustrates an example method 1200 for performing machine learning model substitution during machine learning-based optimization of thermodynamic power generation according to this disclosure. The method 1200 may, for example, be performed using one or more components of the system 100 and the functional architecture 220 described above in order to control operations within the thermodynamic power generation system 102. As a particular example, the method 1200 may be performed during or as part of steps 1010-1014 in the method 1000 of FIG. 10, which would allow for a machine learning model 122 being used during optimization to be retrained or replaced. However, the method 1200 may be performed using any suitable device(s) and in any suitable system(s), and the method 1200 may be used to control any other suitable thermodynamic power generation system(s) (such as the thermodynamic power generation system 300) or other processes.

As shown in FIG. 12, the accuracy of a machine learning model over time is identified at step 1202, and a determination is made that the accuracy is not acceptable at step 1204. This may include, for example, the processing device 202 of the control system 108 or the application server 114 performing or using the statistical system analysis module 242 to compare predicted power generation for one or more thermodynamic power generation components 104 (as predicted using an associated machine learning model 122) with actual power generation by the one or more thermodynamic power generation components 104. This may also include the processing device 202 of the control system 108 or the application server 114 performing or using the statistical system analysis module 242 to determine the error between the predicted power generation and the actual power generation and determine whether the error exceeds a specified threshold (such as a specified percentage or amount difference). If so, this may be indicative that the machine learning model 122 being used is not accurately predicting power generation.

Assuming the machine learning model is not accurately predicting power generation, a determination is made whether the one or more power generation components associated with the machine learning model are actually associated with multiple machine learning models at step 1206. This may include, for example, the processing device 202 of the control system 108 or the application server 114 performing or using the machine learning substitution module 250 to determine whether the machine learning translation module 244 has previously generated multiple models 122 for the same thermodynamic power generation component(s) 104. If there are not multiple models at step 1208, a new machine learning model is trained or the existing machine learning model is retrained at step 1210. This may include, for example, the processing device 202 of the control system 108 or the application server 114 performing or using the machine learning translation module 244 to create a new machine learning model 122 or to retrain the existing machine learning model 122 associated with the thermodynamic power generation component(s) 104, such as based on linear regression or other analysis.

If there are multiple models available at step 1208, a determination is made whether another of the machine learning models is acceptable at step 1212. This may include, for example, the processing device 202 of the control system 108 or the application server 114 performing or using the statistical system analysis module 242 to determine whether another of the machine learning models 122 associated with the thermodynamic power generation component(s) 104 could provide more-accurate power generation predictions, such as based on historical data and a determination whether that machine learning model’s predictions are more accurate than the current machine learning model 122 being used. If not, the process can move to step 1210 in order to train/retrain a machine learning model associated with the thermodynamic power generation component(s) 104. Otherwise, the other machine learning model can be used during subsequent optimization operations at step 1214. This may include, for example, the processing device 202 of the control system 108 or the application server 114 performing or using the machine learning substitution module 250 to deploy the other machine learning model 122 for use by the machine learning optimization module 246 during subsequent optimization operations.

Although FIG. 12 illustrates one example of a method 1200 for performing machine learning model substitution during machine learning-based optimization of thermodynamic power generation, various changes may be made to FIG. 12. For example, while shown as a series of steps, various steps in FIG. 12 may overlap, occur in parallel, occur in a different order, or occur any number of times. Also, there may be any suitable number of machine learning models 122 associated with each thermodynamic power generation component 104 or other component in the system being controlled.

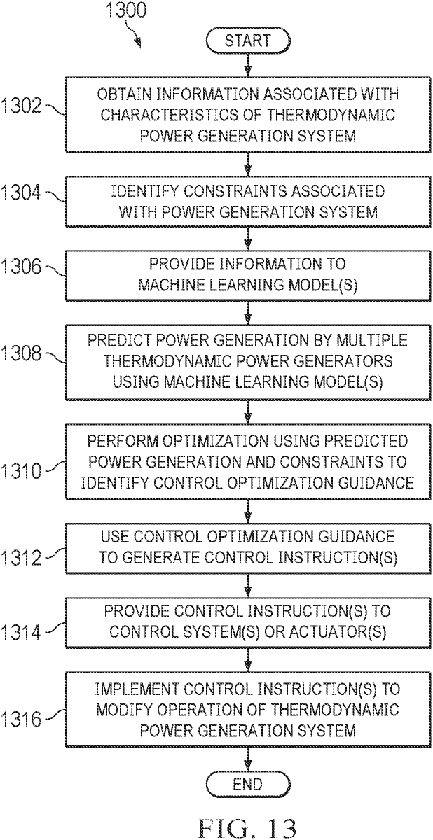

FIG. 13 illustrates an example method 1300 for machine learning-based optimization of a specific steam-based thermodynamic power generation system according to this disclosure. The method 1300 may, for example, be performed using one or more components of the system 100, 300 described above. However, the method 1300 may be performed using any suitable device(s) and in any suitable system(s).

As shown in FIG. 13, information associated with characteristics of a thermodynamic power generation system is obtained at step 1302. This may include, for example, the processing device 202 of the control system 108, 312 or the application server 114 obtaining sensor measurements from the sensors 106, 310, information based on the sensor measurements from the sensors 106, 310, or other information. The obtained information may include information related to flows of steam or other material to and/or from the turbogenerators 304a-304c or other thermodynamic power generation components 104 in the power generation system. In some cases, the obtained information may include one or more of temperature measurements, pressure measurements, specific enthalpy measurements, specific entropy measurements, or steam quality measurements. Pre-processing of the obtained information may occur as described above.

Constrains associated with the power generation system are identified at step 1304. This may include, for example, the processing device 202 of the control system 108, 312 or the application server 114 identifying mass balance constraints, production demands, historical data bounds, and power limits associated with the turbogenerators 304a-304c or other thermodynamic power generation components 104 or associated with other components in the power generation system. In some cases, at least one of these constraints may be determined based on historical data associated with the power generation system.

The information is provided to one or more machine learning models at step 1306. This may include, for example, the processing device 202 of the control system 108, 312 or the application server 114 inputting the information associated with the characteristics of the thermodynamic power generation system to one or more machine learning models 122, 314. Power generation by multiple thermodynamic power generators is predicted at step 1308, and an optimization is performed using the predicted power generation and the constraints to identify control optimization guidance at step 1310. This may include, for example, the processing device 202 of the control system 108, 312 or the application server 114 using the one or more machine learning models 122, 314 to predict how much power could be generated by the turbogenerators 304a-304c or other thermodynamic power generation components 104 in the power generation system. This may also include the processing device 202 of the control system 108, 312 or the application server 114 using the optimizer 316 to determine the optimal flows of steam or other material to or from the turbogenerators 304a-304c or other thermodynamic power generation components 104 so as to increase or maximize the total amount of power generated. The optimizer 316 here can consider the constraints on the turbogenerators 304a-304c or other thermodynamic power generation components 104 or the constraints on the other components in the power generation system. As a result, the control optimization guidance can similarly honor the constraints on the turbogenerators 304a-304c or other thermodynamic power generation components 104 or on the other components in the power generation system.

The identified control optimization guidance may be used in any suitable manner. In this example, the identified control optimization guidance is used to generate one or more control instructions at step 1312. This may include, for example, the processing device 202 of the control system 108, 312 or the application server 114 using the identified control optimization guidance to determine how to adjust one or more actuators 308 (which can be used to control one or more valves 306) so as to provide specified flows of steam or other material to the turbogenerators 304a-304c or other thermodynamic power generation components 104 in order to increase or maximize the amount of power being generated. The one or more control instructions can be provided to one or more control systems or actuators at step 1314, and the one or more control instructions are implemented to modify the operation of the thermodynamic power generation system at step 1316. This may include, for example, the processing device 202 of the control system 108, 312 or the application server 114 providing the control instruction(s) to one or more actuators 308, which can cause the one or more actuators 308 to physically change the openings of one or more associated valves 306 and alter how steam or other material is flowing to the turbogenerators 304a-304c or other thermodynamic power generation components 104.

Although FIG. 13 illustrates one example of a method 1300 for machine learning-based optimization of thermodynamic power generation, various changes may be made to FIG. 13. For example, while shown as a series of steps, various steps in FIG. 13 may overlap, occur in parallel, occur in a different order, or occur any number of times.

The following describes example embodiments of this disclosure that implement or relate to machine learning-based optimization of thermodynamic power generation. However, other embodiments may be used in accordance with the teachings of this disclosure.

In a first embodiment, a method includes analyzing information to be processed, where analyzing the information includes classifying invalid data contained in the information and substituting replacement data in place of at least some of the invalid data in the information. The method also includes training at least one machine learning model based on some of the analyzed information. The method further includes providing other of the analyzed information to the at least one trained machine learning model, where the at least one trained machine learning model is used to generate one or more recommendations based on the analyzed information. In addition, the method includes translating each of the one or more recommendations into one or more actions and generating one or more control instructions based on the one or more actions for at least one of the one or more recommendations.

In a second embodiment, an apparatus includes at least one processing device configured to analyze information to be processed. To analyze the information, the at least one processing device is configured to classify invalid data contained in the information and substitute replacement data in place of at least some of the invalid data in the information. The at least one processing device is also configured to train at least one machine learning model based on some of the analyzed information. The at least one processing device is further configured to provide other of the analyzed information to the at least one trained machine learning model and generate one or more recommendations based on the analyzed information. In addition, the at least one processing device is configured to translate each of the one or more recommendations into one or more actions and generate one or more control instructions based on the one or more actions for at least one of the one or more recommendations.

In a third embodiment, a non-transitory machine readable medium contains instructions that when executed cause at least one processor to analyze information to be processed. The instructions that when executed cause the at least one processor to analyze the information include instructions that when executed cause the at least one processor to classify invalid data contained in the information and substitute replacement data in place of at least some of the invalid data in the information. The non-transitory machine readable medium also contains instructions that when executed cause the at least one processor to train at least one machine learning model based on some of the analyzed information. The non-transitory machine readable medium further contains instructions that when executed cause the at least one processor to provide other of the analyzed information to the at least one trained machine learning model and generate one or more recommendations based on the analyzed information. In addition, the non-transitory machine readable medium contains instructions that when executed cause the at least one processor to translate each of the one or more recommendations into one or more actions and generate one or more control instructions based on the one or more actions for at least one of the one or more recommendations.

Any single one or any suitable combination of the following features may be used with the first, second, or third embodiment. Classifying the invalid data contained in the information may include determining at least one type of invalid data contained in the information. Substituting the replacement data in place of at least some of the invalid data in the information may include generating the replacement data based on the at least one type of invalid data contained in the information. Substituting the replacement data in place of at least some of the invalid data in the information may include imposing bounding conditions on each variable associated with the invalid data, imputing at least one value for each variable associated with the invalid data to generate at least one first replacement value, identifying at least one proxy variable for each variable associated with the invalid data, and deploying the at least one proxy variable for use in generating at least one second replacement value. The replacement data may include the first and second replacement values. Imputing the at least one value for each variable associated with the invalid data may include identifying an average or a most-frequent value for each variable associated with the invalid data. Optimization may be performed using outputs generated by the at least one trained machine learning model, and the one or more recommendations may be based on the optimization. The analyzed information used to train the at least one machine learning model may include historical data included in the analyzed information. The at least one trained machine learning model may include multiple trained machine learning models. It may be determined that a first of the multiple trained machine learning models generates predictions having an error exceeding a threshold and whether a second of the multiple trained machine learning models generates more-accurate predictions and, in response to determining that the second of the multiple trained machine learning models generates more-accurate predictions, the second of the multiple trained machine learning models may be used to generate the one or more recommendations. The one or more recommendations may be associated with a thermodynamic power generation system that includes multiple thermodynamic power generators, and the one or more actions associated with each of the one or more recommendations may include one or more actions that modify operation of the thermodynamic power generation system or one or more of the thermodynamic power generators. The at least one trained machine learning model may be configured to use as inputs only one or both of: (i) input flows of material to the thermodynamic power generators and (ii) output flows of material from the thermodynamic power generators. The multiple thermodynamic power generators may include multiple turbogenerators configured to generate electrical energy based on flows of steam in the thermodynamic power generation system, and the one or more actions associated with each of the one or more recommendations may include one or more actions that control the flows of steam in the thermodynamic power generation system. The one or more control instructions may be implemented to modify operation of at least one component in a system. The one or more recommendations may be generated while honoring constraints on a system being controlled, and one or more of the constraints may be determined based on historical data associated with the system. The one or more recommendations may be generated based on one or more unmetered characteristics associated with a system being controlled, and each unmetered characteristic may be (i) determined based on the analyzed information or (ii) treated as an optimization variable that fluctuates based on at least one other variable.

In still other embodiments, at least one trained machine learning model is used to predict power generated by multiple turbogenerators due to multiple flows of steam through the turbogenerators. The predicted power is used to identify an optimization solution, where the optimization solution identifies or is associated with optimized flows of steam through the turbogenerators to increase or maximize the power generated by the turbogenerators. In some cases, one or more of multiple valves can be adjusted based on the optimization solution, where the valves are configured to control the flows of steam through the turbogenerators. The at least one trained machine learning model may be configured to use as inputs only (i) input flows of steam to the turbogenerators and (ii) output flows of steam from the turbogenerators. The at least one trained machine learning model may be configured to use as inputs (i) input flows of steam to the turbogenerators, (ii) output flows of steam from the turbogenerators, and (iii) at least one of: temperature, pressure, specific enthalpy, specific entropy, or steam quality. The optimization solution may honor constraints on a system that includes the turbogenerators, and one or more of the constraints may be determined based on historical data associated with the system. The optimization solution may be based on one or more unmetered characteristics associated with a system that includes the turbogenerators, and each unmetered characteristic may be either (i) determined based on collected information or (ii) treated as an optimization variable that fluctuates based on at least one other optimization variable.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrases “at least one of” and “one or more of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine.” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
analyzing information to be processed, wherein analyzing the information comprises classifying invalid data contained in the information and substituting replacement data in place of at least some of the invalid data in the information;
training at least one machine learning model based on some of the analyzed information;
providing other of the analyzed information to the at least one trained machine learning model, the at least one trained machine learning model used to generate one or more recommendations based on the analyzed information;
translating each of the one or more recommendations into one or more actions; and
generating one or more control instructions based on the one or more actions for at least one of the one or more recommendations.

2. The method of claim 1, wherein:
classifying the invalid data contained in the information comprises determining at least one type of invalid data contained in the information; and
substituting the replacement data in place of at least some of the invalid data in the information comprises generating the replacement data based on the at least one type of invalid data contained in the information.

3. The method of claim 1, wherein substituting the replacement data in place of at least some of the invalid data in the information comprises:
imposing bounding conditions on each variable associated with the invalid data;
imputing at least one value for each variable associated with the invalid data to generate at least one first replacement value;
identifying at least one proxy variable for each variable associated with the invalid data; and
deploying the at least one proxy variable for use in generating at least one second replacement value; and
wherein the replacement data comprises the first and second replacement values.

4. The method of claim 3, wherein imputing the at least one value for each variable associated with the invalid data comprises identifying an average or a most-frequent value for each variable associated with the invalid data.

5. The method of claim 1, further comprising:
performing optimization using outputs generated by the at least one trained machine learning model, the one or more recommendations based on the optimization.

6. The method of claim 1, wherein the analyzed information used to train the at least one machine learning model comprises historical data included in the analyzed information.

7. The method of claim 1, wherein:
the at least one trained machine learning model comprises multiple trained machine learning models; and
the method further comprises:
determining that a first of the multiple trained machine learning models generates predictions having an error exceeding a threshold;
determining whether a second of the multiple trained machine learning models generates more-accurate predictions; and
in response to determining that the second of the multiple trained machine learning models generates more-accurate predictions, using the second of the multiple trained machine learning models to generate the one or more recommendations.

8. The method of claim 1, wherein:
the one or more recommendations are associated with a thermodynamic power generation system, the thermodynamic power generation system comprising multiple thermodynamic power generators; and
the one or more actions associated with each of the one or more recommendations comprises one or more actions that modify operation of the thermodynamic power generation system or one or more of the thermodynamic power generators.

9. The method of claim 8, wherein the at least one trained machine learning model is configured to use as inputs only one or both of: (i) input flows of material to the thermodynamic power generators and (ii) output flows of material from the thermodynamic power generators.

10. The method of claim 8, wherein:
the multiple thermodynamic power generators comprise multiple turbogenerators configured to generate electrical energy based on flows of steam in the thermodynamic power generation system; and
the one or more actions associated with each of the one or more recommendations comprises one or more actions that control the flows of steam in the thermodynamic power generation system.

11. The method of claim 1, further comprising:
implementing the one or more control instructions to modify operation of at least one component in a system.

12. The method of claim 1, wherein:
the one or more recommendations are generated while honoring constraints on a system being controlled; and
one or more of the constraints are determined based on historical data associated with the system.

13. The method of claim 1, wherein:
the one or more recommendations are generated based on one or more unmetered characteristics associated with a system being controlled; and
each unmetered characteristic is (i) determined based on the analyzed information or (ii) treated as an optimization variable that fluctuates based on at least one other variable.

14. An apparatus comprising:
at least one processing device configured to:
analyze information to be processed, wherein, to analyze the information, the at least one processing device is configured to classify invalid data contained in the information and substitute replacement data in place of at least some of the invalid data in the information;
train at least one machine learning model based on some of the analyzed information;
provide other of the analyzed information to the at least one trained machine learning model and generate one or more recommendations based on the analyzed information;
translate each of the one or more recommendations into one or more actions; and
generate one or more control instructions based on the one or more actions for at least one of the one or more recommendations.

15. The apparatus of claim 14, wherein:
to classify the invalid data contained in the information, the at least one processing device is configured to determine at least one type of invalid data contained in the information; and
to substitute the replacement data in place of at least some of the invalid data in the information, the at least one processing device is configured to generate the replacement data based on the at least one type of invalid data contained in the information.

16. The apparatus of claim 14, wherein, to substitute the replacement data in place of at least some of the invalid data in the information, the at least one processing device is configured to:
impose bounding conditions on each variable associated with the invalid data;
impute at least one value for each variable associated with the invalid data to generate at least one first replacement value;
identify at least one proxy variable for each variable associated with the invalid data; and
deploy the at least one proxy variable for use in generating at least one second replacement value; and
wherein the replacement data comprises the first and second replacement values.

17. The apparatus of claim 16, wherein, to impute the at least one value for each variable associated with the invalid data, the at least one processing device is configured to identify an average or a most-frequent value for each variable associated with the invalid data.

18. The apparatus of claim 14, wherein the at least one processing device is further configured to perform optimization using outputs generated by the at least one trained machine learning model, the one or more recommendations based on the optimization.

19. The apparatus of claim 14, wherein the analyzed information used to train the at least one machine learning model comprises historical data included in the analyzed information.

20. The apparatus of claim 14, wherein:
the at least one trained machine learning model comprises multiple trained machine learning models; and
the at least one processing device is further configured to:
determine that a first of the multiple trained machine learning models generates predictions having an error exceeding a threshold;
determine whether a second of the multiple trained machine learning models generates more-accurate predictions; and
in response to determining that the second of the multiple trained machine learning models generates more-accurate predictions, use the second of the multiple trained machine learning models to generate the one or more recommendations.

21. The apparatus of claim 14, wherein:
the one or more recommendations are associated with a thermodynamic power generation system, the thermodynamic power generation system comprising multiple thermodynamic power generators; and
the one or more actions associated with each of the one or more recommendations comprises one or more actions that modify operation of the thermodynamic power generation system or one or more of the thermodynamic power generators.

22. The apparatus of claim 21, wherein the at least one trained machine learning model is configured to use as inputs only one or both of: (i) input flows of material to the thermodynamic power generators and (ii) output flows of material from the thermodynamic power generators.

23. The apparatus of claim 21, wherein:
the multiple thermodynamic power generators comprise multiple turbogenerators configured to generate electrical energy based on flows of steam in the thermodynamic power generation system; and
the one or more actions associated with each of the one or more recommendations comprises one or more actions that control the flows of steam in the thermodynamic power generation system.

24. The apparatus of claim 14, wherein the at least one processing device is further configured to implement the one or more control instructions to modify operation of at least one component in a system.

25. The apparatus of claim 14, wherein:
the at least one processing device is configured to generate the one or more recommendations while honoring constraints on a system being controlled; and
the at least one processing device is configured to determine one or more of the constraints based on historical data associated with the system.

26. The apparatus of claim 14, wherein:
the at least one processing device is configured to generate the one or more recommendations based on one or more unmetered characteristics associated with a system being controlled; and
for each unmetered characteristic, the at least one processing device is configured to (i) determine the unmetered characteristic based on the analyzed information or (ii) treat the unmetered characteristic as an optimization variable that fluctuates based on at least one other variable.

27. A non-transitory machine readable medium containing instructions that when executed cause at least one processor to:
analyze information to be processed, wherein the instructions that when executed cause the at least one processor to analyze the information comprise:
instructions that when executed cause the at least one processor to classify invalid data contained in the information and substitute replacement data in place of at least some of the invalid data in the information;
train at least one machine learning model based on some of the analyzed information;
provide other of the analyzed information to the at least one trained machine learning model and generate one or more recommendations based on the analyzed information;
translate each of the one or more recommendations into one or more actions; and
generate one or more control instructions based on the one or more actions for at least one of the one or more recommendations.

28. The non-transitory machine readable medium of claim 27, wherein:
the instructions that when executed cause the at least one processor to classify the invalid data contained in the information comprise:
instructions that when executed cause the at least one processor to determine at least one type of invalid data contained in the information; and
the instructions that when executed cause the at least one processor to substitute the replacement data in place of at least some of the invalid data in the information comprise:
instructions that when executed cause the at least one processor to generate the replacement data based on the at least one type of invalid data contained in the information.

29. The non-transitory machine readable medium of claim 27, wherein the instructions that when executed cause the at least one processor to substitute the replacement data in place of at least some of the invalid data in the information comprise:
instructions that when executed cause the at least one processor to:
impose bounding conditions on each variable associated with the invalid data;
impute at least one value for each variable associated with the invalid data to generate at least one first replacement value;
identify at least one proxy variable for each variable associated with the invalid data; and
deploy the at least one proxy variable for use in generating at least one second replacement value; and
wherein the replacement data comprises the first and second replacement values.

30. The non-transitory machine readable medium of claim 29, wherein the instructions that when executed cause the at least one processor to impute the at least one value for each variable associated with the invalid data comprise:
instructions that when executed cause the at least one processor to identify an average or a most-frequent value for each variable associated with the invalid data.

31. The non-transitory machine readable medium of claim 27, further containing instructions that when executed cause the at least one processor to perform optimization using outputs generated by the at least one trained machine learning model, the one or more recommendations based on the optimization.

32. The non-transitory machine readable medium of claim 27, wherein the analyzed information used to train the at least one machine learning model comprises historical data included in the analyzed information.

33. The non-transitory machine readable medium of claim 27, wherein:
the at least one trained machine learning model comprises multiple trained machine learning models; and
the non-transitory machine readable medium further contains instructions that when executed cause the at least one processor to:
determine that a first of the multiple trained machine learning models generates predictions having an error exceeding a threshold;
determine whether a second of the multiple trained machine learning models generates more-accurate predictions; and
in response to determining that the second of the multiple trained machine learning models generates more-accurate predictions, use the second of the multiple trained machine learning models to generate the one or more recommendations.

34. The non-transitory machine readable medium of claim 27, wherein:
the one or more recommendations are associated with a thermodynamic power generation system, the thermodynamic power generation system comprising multiple thermodynamic power generators; and
the one or more actions associated with each of the one or more recommendations comprises one or more actions that modify operation of the thermodynamic power generation system or one or more of the thermodynamic power generators.

35. The non-transitory machine readable medium of claim 34, wherein the at least one trained machine learning model is configured to use as inputs only one or both of: (i) input flows of material to the thermodynamic power generators and (ii) output flows of material from the thermodynamic power generators.

36. The non-transitory machine readable medium of claim 34, wherein:
the multiple thermodynamic power generators comprise multiple turbogenerators configured to generate electrical energy based on flows of steam in the thermodynamic power generation system; and
the one or more actions associated with each of the one or more recommendations comprises one or more actions that control the flows of steam in the thermodynamic power generation system.

37. The non-transitory machine readable medium of claim 27, further containing instructions that when executed cause the at least one processor to implement the one or more control instructions to modify operation of at least one component in a system.

38. The non-transitory machine readable medium of claim 27, wherein:
the instructions when executed cause the at least one processor to generate the one or more recommendations while honoring constraints on a system being controlled; and
the instructions when executed cause the at least one processor to determine one or more of the constraints based on historical data associated with the system.

39. The non-transitory machine readable medium of claim 27, wherein:
the instructions when executed cause the at least one processor to generate the one or more recommendations based on one or more unmetered characteristics associated with a system being controlled; and
the instructions when executed cause the at least one processor, for each unmetered characteristic, to (i) determine the unmetered characteristic based on the analyzed information or (ii) treat the unmetered characteristic as an optimization variable that fluctuates based on at least one other variable.
